(19) United States
(12) Patent Application Publication
(10) Pub. No.: US 2026/0225097 A1
(43) Pub. Date: Aug. 6, 2026

(54) SYSTEMS AND METHODS FOR HIGH-EFFICIENCY MICROFLUIDIC ANALYSIS OF BLOOD

(71) Applicant: The General Hospital Corporation, Boston, MA (US)

(72) Inventors: Seemantini Kadkarni, Boston, MA (US); Nicholas Daniel Uvanovic, Boston, MA (US)

(21) Appl. No.: 19/151,576

(22) PCT Filed: Jan. 29, 2024
(86) PCT No.: PCT/US2024/013375

§ 371 Date: Jul. 28, 2025

Related U.S. Application Data
(60) Provisional application No. 63/441,776, filed on Jan. 28, 2023.

(51) Int. Cl. B01L 3/00

(52) U.S. Cl. CPC B01L 3/502746; B01L 3/502715; B01L 3/52; B01L 2200/025; B01L 2200/027; B01L 2200/0605; B01L 2200/0647; B01L 2200/10; B01L 2200/16; B01L 2300/042; B01L 2300/0867; B01L 2400/0406; B01L 2400/065; B01L 2400/086

(57) ABSTRACT

A fluidic cartridge for mixing a fluid sample with a reagent can include a sample reservoir and a reagent reservoir. The fluidic cartridge can also include a plurality of mixing channels and an imaging chamber. The plurality of mixing channels can define a three-dimensional geometry having a plurality of nodes through which the fluid sample and the reagent flow. The imaging chamber is in fluid communication with the plurality of mixing channels and is dimensioned to receive an analyzable mixture of the fluid sample and the reagent.

### CROSS-REFERENCES TO RELATED APPLICATIONS

The present application is based on, claims priority to, and incorporates herein by reference in its entirety for all purposes, U.S. Provisional Patent Application No. 63/441,776 filed on Jan. 28, 2023.

### STATEMENT REGARDING FEDERALLY SPONSORED RESEARCH

### Not Applicable.

### BACKGROUND

In general, monitoring of blood coagulation and blood coagulation parameters can be useful to better understand causes of hemorrhage, to guide hemostatic therapies, and to predict the risk of bleeding during anesthetic or surgical procedures.

Conventional approaches to monitor the ability of blood to form a clot can include thromboelastography (TEG) and rotational thromboelastometry (ROTEM). These methods are contact-based methods that can strain the clot beyond the linear viscoelastic regime, delay clot formation, or modify the fibrin network structure, which can degrade the characterization of mechanically weaker clots and reduce testing abilities. Moreover, these tests and associated instruments can be bulky, have a plethora of moving parts, require a relatively large quantity of blood, such as on the order of 1 ml (e.g., 1-4 ml), can be complex to operate, can require routine calibration or maintenance, and can have a high cost per test. These and other factors can limit the widespread availability of these tests in clinical settings.

### SUMMARY

The present disclosure provides systems and methods that overcome the drawbacks of traditional attempts to mix fluids with reagents in millifluidic and microfluidic mixers. Prior approaches have been used for passively mixing liquids via 2D serpentine, zigzag, or herringbone structures to split and recombine flow in-plane While these approaches have enabled passive mixing of several biofluids, they are ineffective in whole blood due to differences in the densities and viscosities of blood and reagents, and due to rouleaux formation or stacking of blood cells during laminar flow. In this disclosure, a novel passive millifluidic strategy is developed for rapid and effective whole blood mixing by splitting and recombining fluid streams in 3-dimensions between different planes separated in depth. Further, embodiments of the disclosure allow for precisely metering and advancing blood into one or more channels permitting one or more reagent assays to be simultaneously tested.

In one non-limiting example of this invention, a system and method for processing blood samples is provided that may include a cartridge and multifluidic system for efficiently analyzing the samples. The cartridge may be designed to carry out a mixing strategy and/or a multi-channel illumination process to analyze the samples.

The milli-fluidic mixing concept described herein leverages intrinsic fluid forces to advance blood through a series of inversion mixers and recombination nodes that produce chaotic advection. Thus, continuously splitting, recombining, and folding fluid streams in 3-dimensions limits rouleaux formation and permits effective mixing of whole blood and reagents. Embodiments of the invention further provide on-chip mixing within 5 seconds (inclusive), with coagulation results identical to manual pre-mixing, and high precision between replicate measurements (CoV=0.3-10%) The milli-fluidic mixing strategy is further refined for mixing even low volumes (e.g., 25 μL) of blood by adjusting and optimizing the diameters of chaotic mixers and recombination nodes and exploring the use of hydrophobic surfaces and materials to reduce dead volume. It should be appreciated that certain design parameters can be optimized for benchmarking. These parameters can include lengths and diameters of input, metering and mixing channels, locations of bubble traps, and number of mixer elements. Milli-fluidic mixers described herein can be incorporated within a cartridge assembly for precisely metering and advancing blood (e.g., 25 μL of blood per channel). In one example, the cartridge can be placed into a cartridge slot in the iCoagLAB instrument. Blood can be introduced in the inlet up to a fill indicator line. The cartridge can then be gently pushed further until the final stop. This step pressurizes air in the side rails to advance blood through the reagent wells, picking up the lyobead, driving the mixture via the chaotic mixers to the testing chambers.

In some aspects, the present disclosure provides a fluidic cartridge for mixing a fluid sample with a reagent. The fluidic cartridge can include a sample reservoir dimensioned to receive the fluid sample and a reagent reservoir dimensioned to receive the reagent. The reagent reservoir can be in fluid communication with the sample reservoir. A plurality of mixing channels can be in fluid communication with the reagent reservoir. The plurality of mixing channels can define a three-dimensional geometry (i.e., having turns that redirect flow in three dimensions so that flow is directed and exchanged between distinct planes separated in depth, as opposed to planar zigzags) and include a plurality of nodes through which the fluid sample and the reagent flow. An imaging chamber can be in communication with the plurality of mixing channels. The imaging chamber can be dimensioned to receive an analyzable mixture of the fluid sample and the reagent.

In some aspects, the present disclosure provides a fluidic cartridge for mixing a blood sample with a reagent. The fluidic cartridge can include a sample inlet in fluid communication with a sample reservoir and a reagent inlet in fluid communication with a reagent reservoir. The reagent reservoir may be downstream of the sample reservoir. However, in other embodiments, the sample reservoir may be downstream or parallel with the reagent reservoir. The fluidic cartridge can further include a mixing passageway, a test chamber, and a waste chamber. The mixing passageway can include a plurality of channels and a plurality of nodes. The test chamber can be configured to receive a mixed solution of the blood sample and reagent. The waste chamber can be downstream of the test chamber and dimensioned to receive excess blood sample and reagent.

In some aspects, the present disclosure provides a method of mixing blood and a reagent. The method can include inserting a blood sample into a sample reservoir of a fluidic device, inserting the reagent into a reagent reservoir of the fluidic device, generating a chaotic mixing of the blood sample and the reagent by urging the blood sample and reagent through a mixing passageway having a plurality of combing and recombining nodes, sending a fully mixed solution of the blood sample and the reagent to a test chamber of the fluidic device, and expelling excess blood sample and reagent not accommodated by the test chamber into a waste passageway.

In some aspects, the present disclosure provides a blood coagulation monitoring system. The blood coagulation monitoring system can include a fluid holder to retain a blood sample, a light source, a sensor, and a processor. The fluidic holder can include a plurality of blood reservoirs to retain the blood sample. The light source can include a controller configured to adjust the power or current output of the light source. A light splitter, such as an optical wave guide or diffractive element, for example, can be used to split light emitted from the light source and direct light at each blood reservoir of the plurality of blood reservoirs. The sensor is configured to receive scattered light from the blood sample. The processor can be used to determine parameters of sensed blood coagulation from electrical signals generated by the sensor and generate a report including the parameters of sensed blood coagulation.

In some aspects, the present disclosure provides a microfluidic cartridge for mixing a blood sample and (e.g., with) a reagent. The microfluid cartridge can include a blood reservoir, a reagent reservoir, a plurality of mixing channels, a pumping inlet, and an imaging chamber. The blood reservoir can be dimensioned to receive the blood sample and the reagent reservoir can be dimensioned to receive the reagent. The reagent reservoir can be in fluid communication with the blood reservoir. The plurality of mixing channels can be in fluid communication with the reagent reservoir and can define a plurality of turns through which the blood sample and the reagent can flow. The inlet can be in fluid communication with the plurality of mixing channels. The imaging chamber can be in fluid communication with the plurality of mixing channels and can be dimensioned to receive an analyzable mixture of the blood sample and the reagent.

In some aspects, the present disclosure can provide a method of analyzing a blood sample, and in particular, blood coagulation parameters of a blood sample. Parameters of blood coagulation can be measured using a plurality of assays formed from one or more blood samples.

### BRIEF DESCRIPTION OF THE DRAWINGS

The invention will be better understood and features, aspects, and advantages other than those set forth above will become apparent when consideration is given to the following detailed description thereof. Such detailed description makes reference to the following drawings.

FIG. 1 is a schematic diagram for a blood coagulation monitoring system according to an embodiment of the present disclosure.

FIG. 2 is an isometric view of a holder for a blood sample according to an embodiment of the present disclosure.

FIG. 3 is a top view of a cartridge according to an embodiment of the present disclosure.

FIG. 4 is an isometric view of the cartridge of FIG. 3 and an external pumping system.

FIG. 5A is a top view of a microfluidic cartridge according to an embodiment of the present disclosure.

FIG. 5B is a bottom isometric view of the microfluidic cartridge of FIG. 5A.

FIG. 6A is a top view of a microfluidic cartridge according to another embodiment of the present disclosure.

FIG. 6B is a bottom isometric view of the microfluidic cartridge of FIG. 6A.

FIG. 7A is a semi-transparent side view of a microfluidic cartridge according to another embodiment of the present disclosure.

FIG. 7B a top view of the microfluidic cartridge of FIG. 7A.

FIG. 7C is a bottom isometric view of the microfluidic cartridge of FIG. 7A.

FIG. 8A is a side view of a microfluidic cartridge according to another embodiment of the present disclosure.

FIG. 8B is a top view of the microfluidic cartridge of FIG. 8A.

FIG. 9 is a plurality of microfluidic cartridges according to another embodiment of the present disclosure.

FIG. 10 is an isometric view of a multi-channel helicoidal micromixer according to an embodiment of the present disclosure.

FIG. 11 is a top view of a multi-channel helicoidal micromixer according to another embodiment of the present disclosure.

FIG. 12A is an isometric top view of a millifluidic mixing cartridge according to an embodiment of the present disclosure.

FIG. 12B is a side view of the millifluidic mixing cartridge of FIG. 12A.

FIG. 12C is another side view of the millifluidic mixing cartridge of FIG. 12A.

FIG. 12D is an isometric view of a mixing passageway of the mixing cartridge of FIG. 12A.

FIG. 12E is a graph showing a coagulation parameter versus clotting time illustrating a precision of the millifluidic mixing cartridge of FIG. 12A.

FIG. 13A illustrates mixing within an exemplary mixing cartridge.

FIG. 13B is a graph illustrating a coagulation parameter versus time for a manual pre-mixed mixture of a blood sample and a reagent compared to a mixture formed via passive mixing.

FIG. 14A is a top isometric view of a millifluidic cartridge assembly according to another embodiment of the disclosure.

FIG. 14B is a bottom view of the millifluidic cartridge assembly of FIG. 14A.

FIG. 14C is a schematic representation of the millifluidic cartridge assembly of FIG. 14A and a flow pattern of blood.

FIG. 14D is a schematic representation of the millifluidic cartridge assembly of FIG. 14A and a flow pattern of reagent.

FIG. 15A is a dual-channel mixing cartridge according to an embodiment of the present disclosure, the dual-channel receiving blood at a blood inlet.

FIG. 15B is the dual-channel mixing cartridge of FIG. 15A with blood advancing through the mixing chambers toward reagent chambers.

FIG. 15C is the dual-channel mixing cartridge of FIG. 15A with blood advancing through the test chambers.

FIG. 15D is the dual-channel mixing cartridge of FIG. 15A with blood advancing through a waste chamber.

FIG. 16 is a pump system and millifluidic cartridge according to another embodiment of the present disclosure.

FIG. 17 is a blood coagulation monitoring system according to another embodiment of the present disclosure.

FIG. 18 is a system for illuminating a plurality of test channels on a fluidic cartridge according to another embodiment of the present disclosure.

FIG. 19 is a system for illuminating a plurality of test channels on a fluidic cartridge according to another embodiment of the present disclosure.

FIG. 20 is a system for illuminating a plurality of test channels on a fluidic cartridge according to another embodiment of the present disclosure.

FIG. 21 is a schematic illustration of an optical wave guide system for illuminating a plurality of test channels on a fluidic cartridge according to an embodiment of the present disclosure.

FIG. 22 is a blood coagulation monitoring system according to another embodiment of the present disclosure.

FIG. 23 is an isometric view of a multi-channel fluidic cartridge, allowing multiple reagent assays to be mixed simultaneously according to an embodiment of the present disclosure.

FIG. 24 illustrates an optimization analysis for nodal mixing versus a waste channel length in a fluidic mixing device.

FIG. 25 is an isometric top view of a mixing cartridge having a plurality of layers according to an embodiment of the present disclosure.

FIG. 26 is an exploded isometric view of a mixing cartridge having a plurality of layers according to an embodiment of the present disclosure.

### DETAILED DESCRIPTION

The following discussion is presented to enable a person skilled in the art to make and use examples of the disclosed technology. Various modifications to the illustrated examples will be readily apparent to those skilled in the art, and the generic principles herein can be applied to other examples and applications without departing from the disclosed technology. Thus, examples of the disclosed technology are not intended to be limited to examples shown, but are to be accorded the widest scope consistent with the principles and features disclosed herein. The following detailed description is to be read with reference to the figures, in which like elements in different figures have like reference numerals. The figures, which are not necessarily to scale, depict selected examples and are not intended to limit the scope of examples of the disclosed technology. Skilled artisans will recognize the examples provided herein have many useful alternatives and fall within the scope of disclosed technology.

Before any embodiments of the invention are explained in detail, it is to be understood that the invention is not limited in its application to the details of construction and the arrangement of components set forth in the following description or illustrated in the attached drawings. The invention is capable of other embodiments and of being practiced or of being carried out in various ways. Also, it is to be understood that the phraseology and terminology used herein is for the purpose of description and should not be regarded as limiting. For example, the use of “including,” “comprising,” or “having” and variations thereof herein is meant to encompass the items listed thereafter and equivalents thereof as well as additional items. The use of “about” or “approximately” and variations thereof herein is meant to refer to variation in the numerical quantity that may occur, for example, through the measuring of pressures or temperatures within various portions of a valve assembly that may include embodiments of the disclosure herein; through inadvertent error in these procedures; through differences in the accuracy or precision of various components used to carry out the methods; and the like. Throughout the disclosure, the terms “about” and “approximately” are intended to refer to a range of values±15% of the numeric value that the term proceeds, inclusive.

As used herein, unless otherwise specified or limited, the terms “mounted,” “connected,” “supported,” “secured,” and “coupled” and variations thereof, as used with reference to physical connections, are used broadly and encompass both direct and indirect mountings, connections, supports, and couplings. Further, unless otherwise specified or limited, “connected,” “attached,” or “coupled” are not restricted to physical or mechanical connections, attachments or couplings.

Also as used herein, unless otherwise limited or defined, “or” indicates a non-exclusive list of components or operations that can be present in any variety of combinations, rather than an exclusive list of components that can be present only as alternatives to each other. For example, a list of “A, B, or C” indicates options of: A; B; C; A and B; A and C; B and C; and A, B, and C. Correspondingly, the term “or” as used herein is intended to indicate exclusive alternatives only when preceded by terms of exclusivity, such as “only one of,” or “exactly one of.” For example, a list of “only one of A, B, or C” indicates options of: A, but not B and C; B, but not A and C; and C, but not A and B. In contrast, a list preceded by “one or more” (and variations thereon) and including “or” to separate listed elements indicates options of one or more of any or all of the listed elements. For example, the phrases “one or more of A, B, or C” and “at least one of A, B, or C” indicate options of: one or more A; one or more B; one or more C, one or more A and one or more B; one or more B and one or more C; one or more A and one or more C; and one or more A, one or more B, and one or more C. Similarly, a list preceded by “a plurality of” (and variations thereon) and including “or” to separate listed elements indicates options of multiple instances of any or all of the listed elements. For example, the phrases “a plurality of A, B, or C” and “two or more of A, B, or C” indicate options of: one or more A and one or more B; one or more B and one or more C; one or more A and one or more C, and one or more A, one or more B, and one or more C.

In some embodiments, aspects of the invention, including computerized implementations of methods according to the invention, can be implemented as a system, method, apparatus, or article of manufacture using standard programming or engineering techniques to produce software, firmware, hardware, or any combination thereof to control a processor device (e.g., a serial or parallel general purpose or specialized processor chip, a single-or multi-core chip, a microprocessor, a field programmable gate array, any variety of combinations of a control unit, arithmetic logic unit, and processor register, and so on), a computer (e.g., a processor device operatively coupled to a memory), or another electronically operated controller to implement aspects detailed herein. Accordingly, for example, embodiments of the invention can be implemented as a set of instructions, tangibly embodied on a non-transitory computer-readable media, such that a processor device can implement the instructions based upon reading the instructions from the computer-readable media. Some embodiments of the invention can include (or utilize) a control device such as an automation device, a special purpose or general purpose computer including various computer hardware, software, firmware, and so on, consistent with the discussion below. As specific examples, a control device can include a processor, a microcontroller, a field-programmable gate array, a programmable logic controller, logic gates etc., and other typical components that are known in the art for implementation of appropriate functionality (e.g., memory, communication systems, power sources, user interfaces and other inputs, etc.). In some embodiments, a control device can include a centralized hub controller that receives, processes and (re)transmits control signals and other data to and from other distributed control devices (e.g., an engine controller, an implement controller, a drive controller, etc.), including as part of a hub-and-spoke architecture or otherwise.

As used herein in the context of computer implementation, unless otherwise specified or limited, the terms “component,” “system,” “module,” “block,” “device,” and the like are intended to encompass part or all of computer-related systems that include hardware, software, a combination of hardware and software, or software in execution. For example, a component may be, but is not limited to being, a processor device, a process being executed (or executable) by a processor device, an object, an executable, a thread of execution, a computer program, or a computer. By way of illustration, both an application running on a computer and the computer can be a component. One or more components (or system, module, and so on) may reside within a process or thread of execution, may be localized on one computer, may be distributed between two or more computers or other processor devices, or may be included within another component (or system, module, and so on).

Also as used herein, unless otherwise limited or defined, “configured to” indicates that a component, system, or module is particularly adapted for the associated functionality. Thus, for example, an NN configured to MM is specifically adapted to MM, as opposed to merely being generally capable of doing so.

In some implementations, devices or systems disclosed herein can be utilized, manufactured, installed, etc. using methods embodying aspects of the invention. Correspondingly, any description herein of particular features, capabilities, or intended purposes of a device or system is generally intended to include disclosure of a method of using such devices for the intended purposes, of a method of otherwise implementing such capabilities, of a method of manufacturing relevant components of such a device or system (or the device or system as a whole), and of a method of installing disclosed (or otherwise known) components to support such purposes or capabilities. Similarly, unless otherwise indicated or limited, discussion herein of any method of manufacturing or using for a particular device or system, including installing the device or system, is intended to inherently include disclosure, as embodiments of the invention, of the utilized features and implemented capabilities of such device or system.

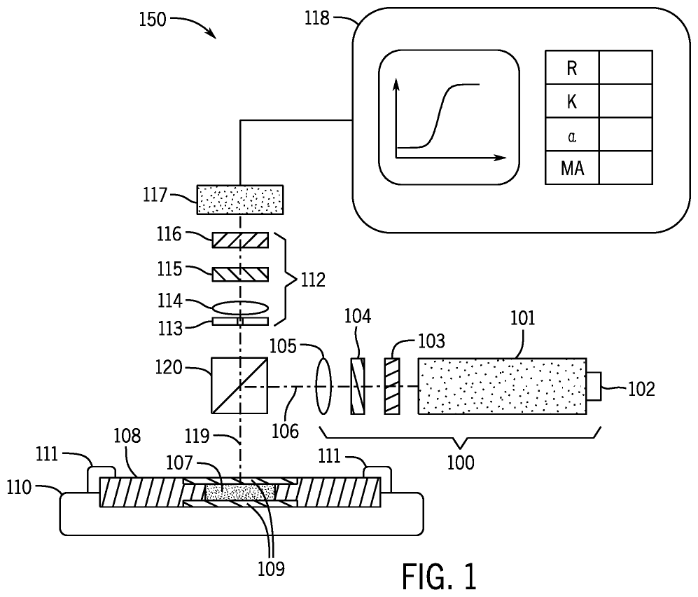

FIG. 1 illustrates a general blood coagulation monitoring system 150 according to an embodiment of the disclosure. The blood coagulation monitoring system 150 includes a coherent light source 100. The coherent light source 100 can incorporate a coherent light source 101, such as a continuous wave or pulsed laser, for example, that emits coherent light. The wavelength of light can be from approximately 600 nm to approximately 800 nm, or can be between 650 nm and 750 nm, and in some preferred embodiments, may be 690 nm. In some embodiments, the coherent light source 100 can include collimation optics that can collimate a light, for example, that is illuminated on a blood sample, which may be held by a blood sample holder.

The coherent light source 100 can include a controller 102 that can control an output power of light or output current for light. Controlling output power of light can provide uniform illuminated power on blood samples to minimize results of coagulation parameters among different samples. Controlling output current for light can suppress change of wavelength causing speckle instability. Thus, the controller 102 can reduce unwanted speckle instability when illuminating a blood sample.

To stabilize wavelength, a wavelength filter 103 can be placed in front of the coherent light source 101. Light passing through a wavelength filter 103 can pass through a linear polarizer 104 to change a polarization state of light and standardize the polarization state of light illuminated on blood samples. Light passing through the linear polarizer 104 can also pass through a lens 105 that collimates or focuses light on a blood sample. Collimated or quasi-collimated illumination uniformly illuminates the blood sample and then can reduce position dependency on the blood sample, but power density is low. On the other hand, focused illumination improves power density and then light reaches to a deeper depth in the blood sample, but some results may be affected by the uniformity of the blood sample.

The method of illumination can be modified based on blood samples and necessary data. The light passing through the wavelength filter 103, the linear polarizer 104, and the lens 105 can define an optical axis 106 and is illuminated on a blood sample 107 through a beam splitter 120. The blood sample 107 can be sealed in a blood sample chamber 108 with a transparent sheet 109, and the blood sample chamber 108 can be placed on a holder 110. In some examples, the holder 110 can incorporate a heat plate under the blood sample chamber 108 with a temperature controller (e.g., a thermostat) to stabilize the blood sample 107 at a selected temperature (e.g., 37 degrees Celsius or another temperature, such as room temperature).

In some examples, the holder 110 can also incorporate a clamping mechanism 111 to secure the blood sample chamber 108 during measurement and to exchange the blood sample chamber 108. Light passing through the transparent sheet 109 and penetrating the blood sample 107 can be scattered by scattering particles such as red blood cells, platelets, and fibrin, for example. Some scattered light can reach an imaging optics unit 112. In some embodiments, the imaging optics unit 112 can include a focal length from 5 mm to 50 mm. The imaging optics unit 112 can include an aperture 113, a lens 114, a linear polarizer 115, and a neutral-density filter 116. In some embodiments, the imaging optics unit 112 may be detachable between lenses. The optical density of the neutral-density filter 116 may be between 0.1 and 3.0. In some embodiments, the imaging optics unit 112 can include a plurality of axes.

In use, the scattered light from the blood sample can then be captured on a sensor 117. In some examples, the sensor 117 may include one or more photodiodes, two-dimensional charged-coupled devices, or a two-dimension complementary metal-oxide-semiconductor. In some examples, an exposure time of the sensor 117 may be between 200 msec and 800 msec. However, in other examples, the exposure time of the sensor 117 may be between 300 μsec and 1000 μsec.

Generally, as the light is coherent light, scattered light in the blood sample 107 can be interfered constructively and destructively with each other, and then bright and dark spots, e.g., speckle patterns, can be imaged on a sensor surface in the sensor 117 through the aperture 113 and the lens 114. In some embodiments, the aperture 113 can define a diameter that is between 250 μm and 1000 μm. The linear polarizer 115 is used to select polarization state of speckle image. When a cross polarization state (which is perpendicular to the polarization state of the illumination light) is selected, a speckle pattern is dominantly influenced by multiple scattering events in blood sample. On the other hand, when using a parallel polarization state (which is parallel to the polarization state of the illumination light) is selected, a speckle pattern is dominantly influenced by a few scattering events in blood sample.

A neutral-density filter can be used to adjust light intensity on a sensor in the sensor 117. Speckle patterns obtained by the sensor in the sensor 117 can be changed into electrical signals and transferred to a processor 118, which is the processor 118 can determine blood coagulation parameters. The processor 118 calculating blood coagulation parameters can use a method of intensity autocorrelation function that can extract blood coagulation parameters. A method of intensity autocorrelation function can use varied sampling time periods. In some examples, a processor calculating blood coagulation parameters can use a method of spatial speckle contrast that can extract blood coagulation parameters. Additionally or alternatively, in some embodiments, a processor calculating blood coagulation parameters can use a method of temporal speckle contrast that can extract blood coagulation parameters.

The processor 118 can output and show a blood coagulation graph and several coagulation parameters. R value is a time period of latency from starting point of measurement to point of initial fibrin formation. K value is a time period that achieves a certain level of blood clot strength. Angle a value is speed of forming fibrin and cross-link, and is equivalent to the rate of clot strengthening. Maximum amplitude (MA) is the maximum strength of fibrin and platelet bonding via GPIIb/IIIa. The processor 118 can include a central processing unit or a graphics processing unit, memory, storages, and display, and can be, for example, a laptop personal computer or a smart phone device.

With continued reference to FIG. 1, the optical axis 106 of the coherent light source 100 and the optical axis 119 of the imaging optics unit 112 and the sensor 117 are perpendicular through the beam splitter 120. Generally, in some embodiments, the optical axis 106 and the optical axis 119 can extend in nonparallel directions. The beam splitter 120 can be a half mirror or a polarization beam splitter, for example, and can be used for matching the optical axis 106 and the optical axis 119 on the blood sample 107. However, it should also be understood that the optical axis 106 and the optical axis 119 can be inclined to the normal axis of the blood sample chamber 108 without using a beam splitter.

As shown in FIG. 1, the blood sample 107 or the surface of the transparent sheet 109 is conjugate with a sensor plane of the sensor 117. The aperture 113 can be used for defining a size of speckles and is preferably located at or close to pupil position of an imaging optics. The minimum of speckle size is approximately 2 times of pixel size of the sensor in the sensor 117, but the preferable speckle size is around approximately 7 times of the pixel size in the sensor 117. Also illustrated in FIG. 1, the aperture 113 is located close to the lens 114, but when the sensor 117 has an internal single lens or multiple lenses, the internal single lens of one of the multiple lenses can be alternative to the aperture 113.

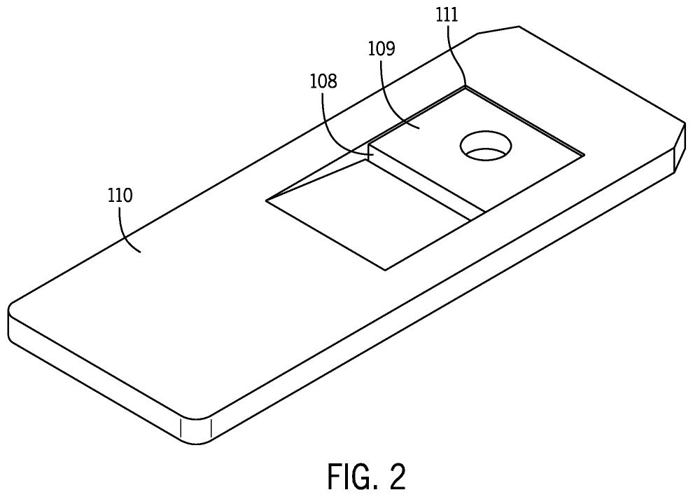

FIG. 2 illustrates a schematic diagram of the holder 110 for the blood sample chamber 108 according to one embodiment of the disclosure. In use, the blood sample chamber 108 can be filled at a circular cylinder located at the center of the blood sample chamber 108. The sample can then be covered by the transparent sheet 109 at the top and bottom sides. The blood sample chamber 108 can then be inserted into the clamping mechanism 111 to be secured perpendicular to the axis 119. A volume of the blood sample 107 may preferably be approximately 25 μL with a 2 mm thickness to obtain enough multiple scattering events from the blood sample 107. In other embodiments, the volume of the blood sample 107 may be between 15 and 40 μL with a thickness of 1 mm to 3 mm.

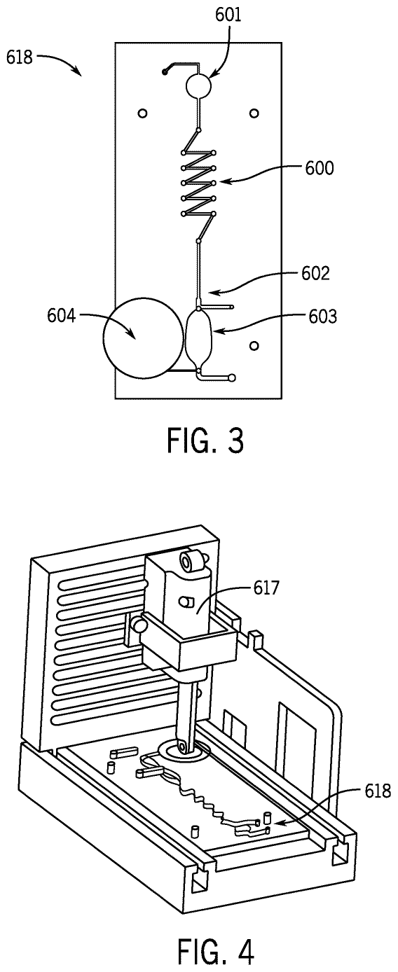

As shown in FIG. 3, other cartridges (e.g., fluidic cartridges or holders) can be used in a blood coagulation monitoring system, such as the blood coagulation monitoring system 150 of FIG. 1 or others. In particular, a fluidic cartridge, which may be configured as a microfluidic or millifluidic cartridge allowing mixing of fluid volumes from approximately 5 microliters to approximately 200 microliters, according to some embodiments of the disclosure, can be disposable and can allow for rapid automated mixing of blood and reagent. The cartridge 618 can include a blood reservoir 603, a reagent reservoir 602, inversion mixing channels 600, an imaging chamber 601, and a pumping inlet 604.

In use, after blood and a corresponding reagent is added to the cartridge 618 and sealed, an external electro-mechanical pumping system 617 (as shown in FIG. 4) can apply a controlled plunging pressure force at the pumping inlet 604. The plunging pressure force can displace the added fluid through the inversion chambers 600. That fluid can travel back and forth through the inversion chambers 600 a plurality of times, (e.g., three times), which can allow for complete mixing of the blood and reagent to provide an analyzable mixture. The fluid can then travel to the imaging chamber 601 for analysis via an external optical system (e.g., the imaging optics unit 112 of FIG. 1). The blood reservoir 603 and the reagent reservoir 602 can be filled with 110 μL and 10 μL, respectively. Due to the back and forth displacement needed to fully mix the fluids, the process can take approximately 10 seconds before the fluid travels to the imaging chamber 601, whereas conventional approaches can take a longer amount of time.

As shown in FIG. 4, the cartridge 618 can be secured relative to the pumping system 617 so that the pumping system 617 engages the microfluidic cartridge at the pumping inlet 604. In use, the pumping system 617 can be actuated to apply a change in pressure to the chambers 600 to efficiently and effectively mix the blood sample and the reagent. The cartridge 618 can be secured relative to the pumping system 617 via a cartridge holder that allows for quick connect and disconnect of the cartridge 618. For example, the cartridge 618 may be slid in an out of alignment relative to the pumping system 617. In particular, when the cartridge 618 is slid relative to the cartridge holder, the cartridge 618 can engage a stop member (e.g., via abutting a portion of the cartridge holder) which places the pumping inlet 604 in alignment with the pumping system 617.

Generally, the cartridge 618 of FIG. 4 permits an active mixing of blood and requires an external pumping mechanism that may be actuated a plurality of times. This active mixing can be time consuming, cumbersome, and expensive. Thus, embodiments of the invention provide systems and methods for passive microfluidic and millifluidic mixing that can address these and other drawbacks of active mixing. In particular, embodiments of the present disclosure provide systems and methods of passive mixing (e.g., mixing that can occur without external or repeated input from a pump or other device).

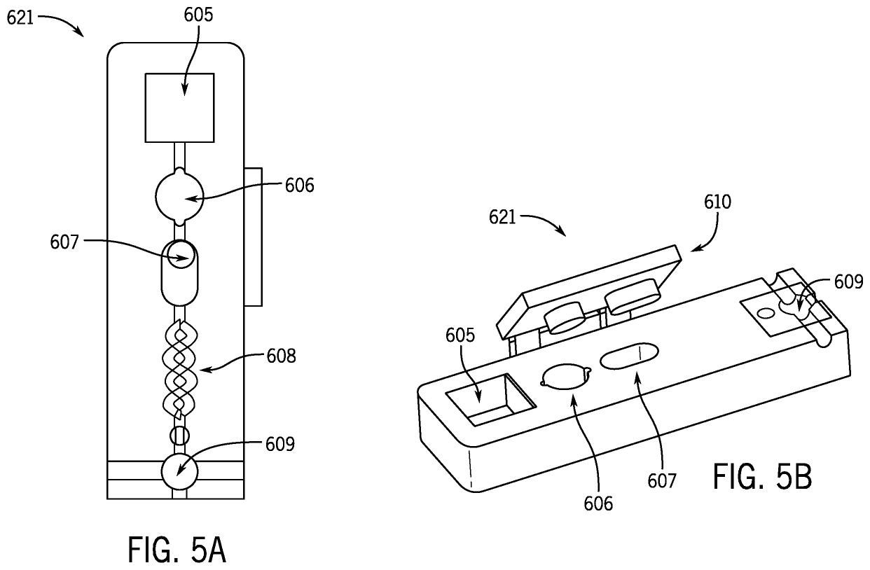

In general, microfluidic mixing can refer to mixing a first fluid (e.g., blood) having a volume between 1 and 25 μL (inclusive). Likewise, millifluidic mixing can refer to mixing a first fluid (e.g., blood) having a volume that is greater than (or equal to) 20 μL (e.g., approximately 20-400 μL). Thus, embodiments of the present disclosure demonstrate systems and methods for both microfluidic and millifluidic mixing of blood with wet and dry reagent(s) stored in or added to a cartridge, such as one of the cartridges described herein, and in particular, described in FIGS. 5-12.

The millifluidic mixers described below with reference to FIGS. 5-12 can be incorporated within a test cartridge assembly with a plurality of test channels or chambers that allows for precise metering and on-chip mixing of a small amount of blood (e.g., between 5 and 200 μL) per channel.

FIGS. 5A and 5B illustrate an example embodiment of a microfluidic cartridge 621 according to an embodiment of the disclosure. In some embodiments, the microfluidic cartridge 621 may be disposable. In some embodiments, the microfluidic cartridge 621 can allow blood and a reagent to mix with only one applied plunge from an external pump. Or, in a preferred embodiment, the microfluidic cartridge 621 can allow blood and a reagent to mix simply and advantageously by introducing blood in the inlet, and capping the inlet. By capping the inlet, a small volume of air can advance the blood through channels of the cartridge to effectively mix the blood and reagent. In general, this method of mixing can significantly decrease the mixing time and allow for simplified control over the displacement of the fluids.

The microfluidic cartridge 621 can include a blood reservoir 606, a reagent reservoir 607, 3D cross-linked dual helical mixing channels 608, an imaging chamber 609, and a pumping inlet 605. In some embodiments, the blood reservoir 606 may only require approximately 45 μL to fill and the reagent reservoir may require approximately 7 μL, which may be significantly less compared to the cartridge 618. After filling the reservoirs 606, 607, a fastening cap 610 can be closed to provide a complete seal to the fluid reservoirs 606, 607. In some embodiments, an external pump can be used to apply a plunging force to the pumping inlet 605 of the microfluidic cartridge 621, however, in a preferred embodiment, an external pump, such as the pump 617 shown in FIG. 4, is not necessary.

For example, simply capping the inlet to the fluid reservoirs 606, 607 with the cap 610 can displace a precise volume of air so that a metered volume of blood advances toward the reagent chamber and onward toward the helicoidal microfluidic mixing channels 608. The mixing channels 608 can provide efficient and full mixing of the fluids or fluid with dry reagent (e.g., lyophilized beads) before they (i.e., as a mixture of blood and reagent) travel to the imaging chamber 609 for analysis via an external optical system. The full mixing of the blood with the reagent can occur quickly and efficiently (e.g., on the order of 5-10 seconds). Thus, an appropriate and effective mixture can reach the imaging chamber 609 for accurate analysis in approximately under 10 seconds.

In the illustrated example, the plurality of mixing channels 608 can be arranged as part of a series of mixing elements and can include first and second channels that are inner woven (e.g., to form a helix) and can each include a plurality of bends (e.g., turns). For example, each channel of the double helix can include at least four turns. Both of the channels may be in fluid communication with each other so that when a pumping action is applied to the pumping inlet 605 (which is also in fluid communication with the plurality of mixing channels 608), fluid within the mixing channels can be circulated through the helix shape and effectively mixed. In some embodiments, a plurality of mixing channels may have sufficient bends so that a single circulation through the circuit formed by the mixing channels sufficiently mixes a blood sample and a reagent to be effectively analyzed by an optical system, such as the sensor 117, for example.

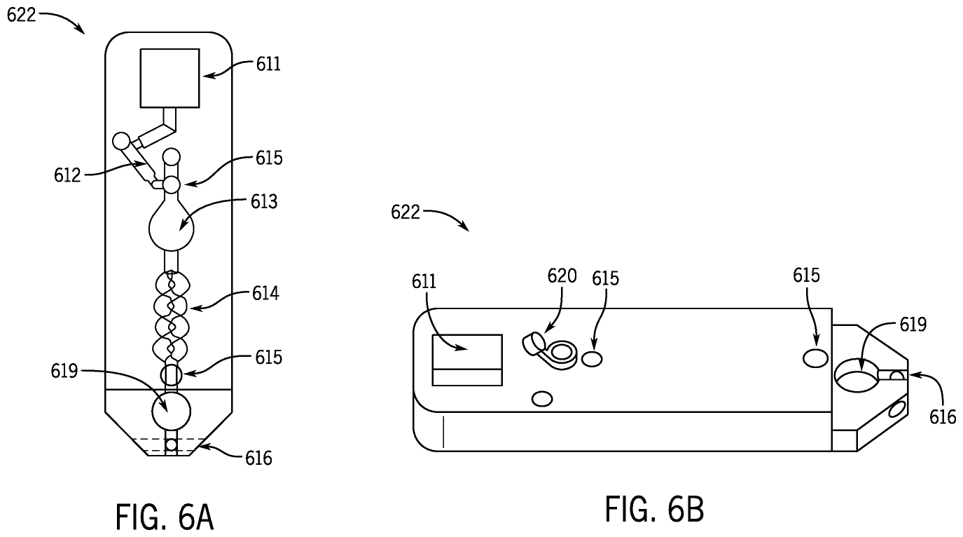

FIGS. 6A and 6B illustrate another example embodiment of a fluidic cartridge 622 according to another embodiment of the disclosure. The fluidic cartridge 622 can be configured as a millifluidic cartridge or a microfluidic cartridge. The fluidic cartridge 622 can include a blood reservoir 613, a reagent reservoir 612, 3D cross-linked dual helical mixing channels 614, an imaging chamber 619, and, optionally, a pumping inlet 611. The fluidic cartridge 622 can also include certain optimized design features, including air bubble traps 615 and overfill channels or chambers 616. The blood reservoir 613 may require approximately 45 μL to fill and the reagent reservoir may require approximately 7 μL to fill. After filling the reservoirs, 612, 613, a fastening cap 620 can be closed to provide a complete seal to the reservoirs 612, 613.

In use, an external pump (e.g., the external pump 617 shown in FIG. 4) is not required to apply a plunging pressure force to fluidic cartridge 622. In contrast, the three-dimensional (e.g., helicoidal) micromixer geometry of the fluidic cartridge 622 can provide capillary flow-driven mixing of fluids (or fluids and solids), and does not require an external pumping mechanism. Instead, via the use of small diameter capillary channels that are formed as three dimensional helicoidal structures, mixing is achieved. In the illustrated example, minute blood volumes (e.g., less than 25 μL) can be used for mixing with wet or dry reagents such as lyophilized powder or bead reagents. Advantageously, this form factor allows for a short mixing time and due to the nature of capillary action, drastically reduces or eliminates air bubbles from being introduced into the test chamber.

The blood reservoir 613 may be offset from the reagent reservoir 612 to allow for improved control of the fluid displacement during a filling process and a sealing process. Capillary break channels can be included to resist motion without an external pressure added. In some embodiments, this can prevent unwanted mixing before the application of a pump. However, it should be appreciated that preferred embodiments do not require a pump. During the capillary mixing, fluids can meet and mix through the helical mixing channels 614 before entering into the imaging chamber 619. Excess fluid can escape through the overfill chambers 616 and to create a constant volume of approximately 25 μL in the imaging chamber 619. Thus, the mixing chamber 616 can define an appropriate volume (e.g., 25 μL, or other volumes) so that the mixture containing the blood sample can be effectively analyzed.

In general, capillary flow-driven microfluidics is dictated by surface tension and adhesion between a liquid and a material, and can be controlled by adjusting a diameter of a microfluidic channel through which the capillary flow is driven. The fluidic cartridge 622, and other capillary-compatible fluidic cartridges described herein, include helicoid mixing channels with small-diameter channels (e.g., smaller than the channels of the cartridge 618 shown in FIG. 3) to mediate capillary flow, as well as a blood and filling inlet. Due to the nature of capillary-driven flow, consistent flow rate and mixing is achieved with no external influences. In addition, limited to no air bubbles would be introduced into a cartridge, and a stable mixture volume (e.g., 1-25 L) is maintained during analysis.

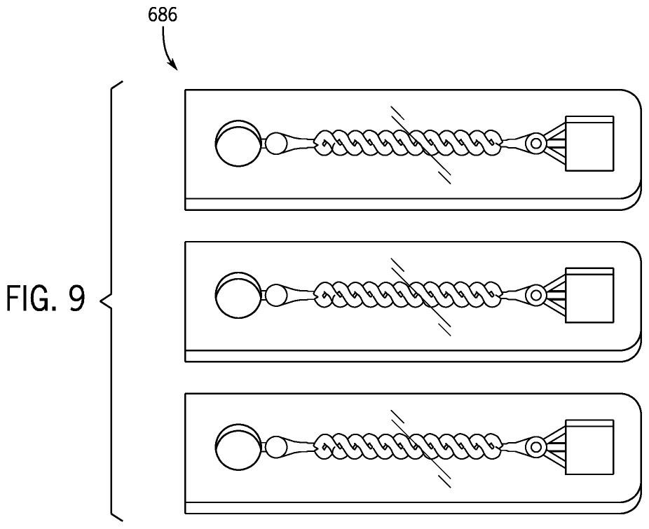

Some conventional mixing approaches may include passive micro-or milli-fluidic mixing via the use of two-dimension serpentine, zigzag, or herringbone structures to split and recombine flow in-plan or in a two-dimensional plane. Such conventional approaches are often ineffective for the whole blood mixing due to differences between the densities and viscosities of the blood and reagents. Further inefficiencies can also be due to rouleaux formation or stacking of blood cells during flow. Thus, embodiments of the present invention (see, for example, FIGS. 5-12) address these and other drawbacks of conventional mixing methods. In particular, three-dimensional zigzags or turns, such as helicoidal microfluidic structures (see, for example, FIGS. 5-8) and recombinant chaotic structures (see, for example, FIGS. 9-12) show non-conventional and improved mixing strategies for rapid and effective whole blood mixing that overcomes the limitations of conventional approaches by splitting recombining fluid streams in three dimensions and mixing within approximately 2-10 seconds, inclusive.

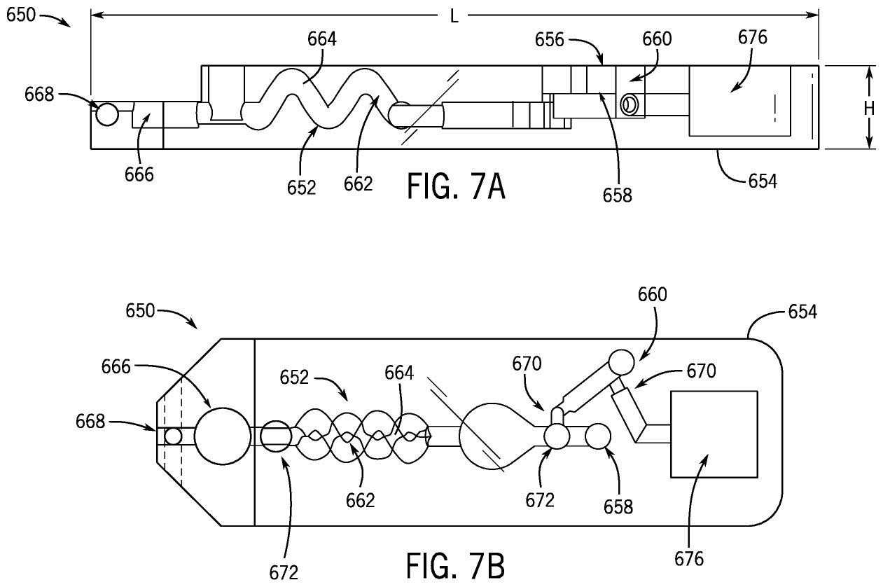

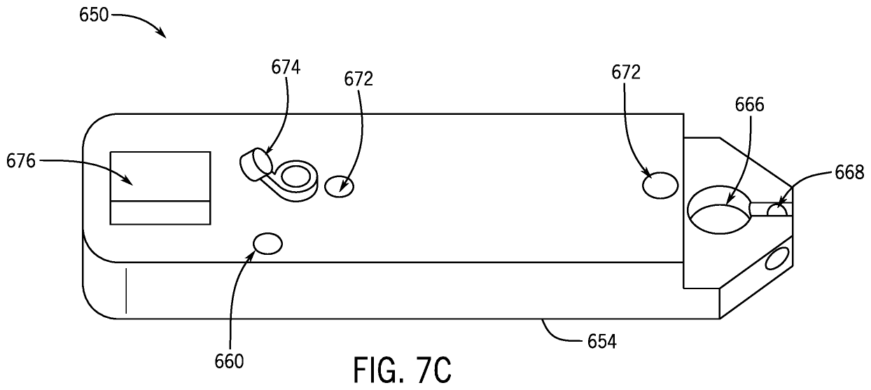

Referring now to FIGS. 7A-C, an embodiment of a microfluidic cartridge 650 is shown. The microfluidic cartridge 650 includes cross-linked helicoids 652. The helicoids 652 generally have a high mixing efficiency for small blood volumes (e.g., less than approximately 25 μL or between approximately 1 and 25 μL). The helicoids 652 provide collision-based mixing of blood and reagents (solid or liquid). The collision-based mixing does not rely (i.e., does not require) back and forth flow to diffusively mix blood and a reagent. Thus, adequate mixing can be accomplished with just a single plunge or applied pressure force by capping the inlet, similar to the cap 610 of FIG. 5B.

Similar to the cartridges described with reference to FIGS. 5 and 6, the microfluidic cartridge 650 can include a body 654 that defines a body length L and a height H. The cartridge 650 further includes an inlet 656 (see FIG. 7C) to a blood reservoir 658. The blood reservoir 658 is in fluid communication with a reagent reservoir 660. The cartridge 650 also includes mixing elements such as mixing channels 662 and nodes 664, an imaging chamber 666, and overfill chambers 668. The flow path within the body 654 also includes capillary brakes 670 and bubble traps 672.

In use, a reagent, such as kaolin, for example, may be inserted into the reagent reservoir 660 and sealed, thereby forming a pre-sealed reagent reservoir 660. Next, a blood sample may be placed into the blood reservoir 658 via the inlet 656. A reservoir cap 674 can be closed at the inlet 656 to provide a displacement of air to send the blood sample and reagent through the mixing channels 662 to effectively mix the blood and reagent to form a mixture for analysis at the imaging chamber 666. The blood sample can flow through the plurality of nodes 664 to mix with the reagent such that the blood sample and reagent can be split at each node and recombined at each node. Each recombination of the blood and reagent at each node can facilitate mixing and preparing a finalized mixture once the blood and reagent have traveled through each of the nodes to the imaging chamber 666. The capillary brakes 670 can be used to stop unwanted flow, such as before the reservoir cap 674 is shut or sealed at the inlet 656. The bubble traps 672 can be used to remove any bubbles from the liquids or mixture so that mixture received at the imaging chamber 666 is free of unwanted air pockets that may disrupt analysis. The overfill chambers 668 can be used to disperse excess material, such as the blood or mixture, so that only a prescribed amount of mixture is present in the imaging chamber 666.

In some embodiments, a plunger (not shown in FIGS. 7A-C) may be inserted at a plunger inlet 676 of the cartridge 650 to initiate the mixing the blood and the reagent. However, in other embodiments, the displacement of air (e.g., applied pressure force) resulting from closing the reservoir cap 674 may be sufficient to initiate and complete the mixing process and send the mixture to the imaging chamber 666.

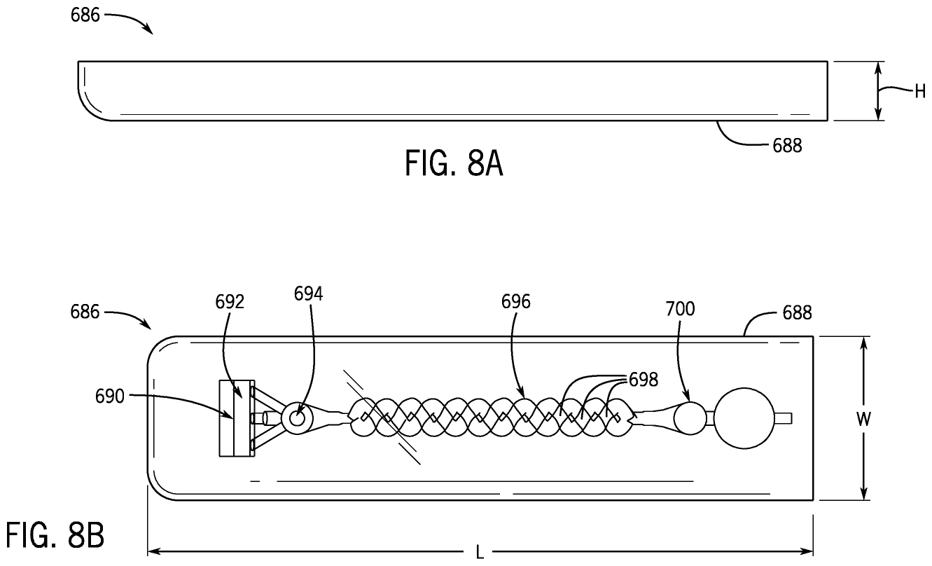

FIGS. 8A and 8B illustrate an embodiment of a single channel helicoidal micromixer cartridge 686. The cartridge 686 is configured to provide capillary flow-driven mixing of fluids and does not require an external pumping mechanism. The cartridge 686 advantageously uses small-diameter capillary channels and provides effective mixing of minute blood volumes (e.g., less than 25 μL) with a reagent. In the illustrated embodiment, the reagent may be a wet or dry reagent. This embodiment can provide a short mixing time and due to the nature of capillary action, reduces or eliminates air bubbles.

In general, capillary flow-driven microfluidics is dictated by surface tension and adhesion between liquid and material, and can be controlled by adjusting the diameter of microfluidic channels. The cartridge 686 can employ similar helicoid mixing channels as described above, with smaller diameter channels to mediate capillary flow, as well as blood and filling inlet.

The cartridge 686 can include a body 688 that defines a body length L, width W, and a height H. The cartridge 686 can further include an inlet 690 to a blood reservoir 692. The blood reservoir 692 can be in fluid communication with a pre-filled reagent reservoir 694. The cartridge 686 includes mixing channel 696 having a plurality of nodes 698. The mixing channels 696 can direct fluid in three-dimensions (e.g., relative to the height, width, and length) of the cartridge 686.

In use, blood can be deposited into the blood reservoir 692 and then, via either capillary flow, or by introduction via a syringe or pipette, moved toward the reagent reservoir 694 to mix with a reagent to form a mixture. The mixture can then move through the mixer nodes toward an analysis region or an imaging chamber 700 for analysis. Various parameters of the cartridge 686, or other cartridges described herein, can be adjusted to increase or decrease mix time or to accommodate for different blood volumes or reagent types or quantities. For example, these parameters can include cartridge length L, cartridge width W, cartridge height H, number of nodes, or mixing channel geometry.

FIG. 9 illustrates examples of 3D printed cartridges. Like the cartridges described above, these cartridges can include a blood reservoir and a reagent reservoir in fluid communication with mixing channels that can mix the blood and the reagent via capillary action.

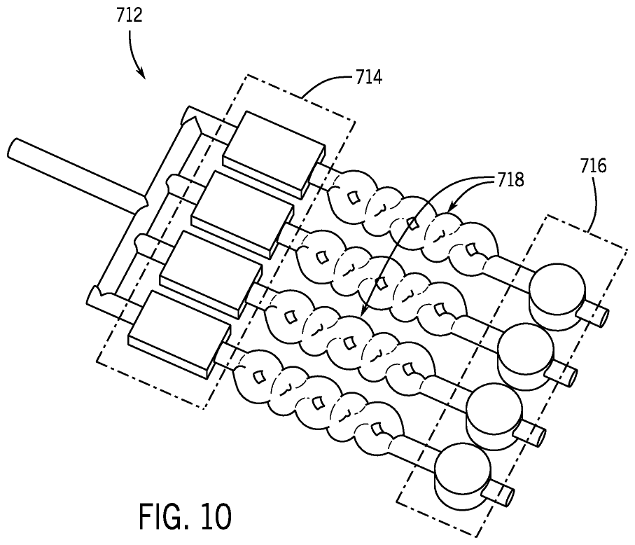

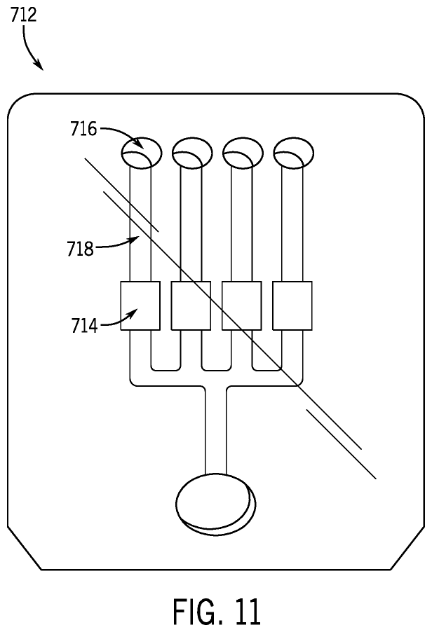

FIG. 10 illustrates a multi-channel cartridge 712 according to an embodiment of the disclosure. The multi-channel cartridge 712 includes a plurality of reagent areas 714 and a respective plurality of imaging areas 716. In the illustrated example, the multi-channel cartridge 712 includes four reagent areas 714 and four imaging areas 716, however, other quantities of areas are possible. The illustrated four-channel micromixer 712 can receive a single blood input and then, via capillary filling, can mix with reagents to move to the respective imaging areas 716 for analysis. As shown in the illustrated embodiment, each reagent area 714 is in fluid communication with a respective imaging area 716 via a helical mixing channel 718. FIG. 11 illustrates a 3D printed version of the cartridge of 712.

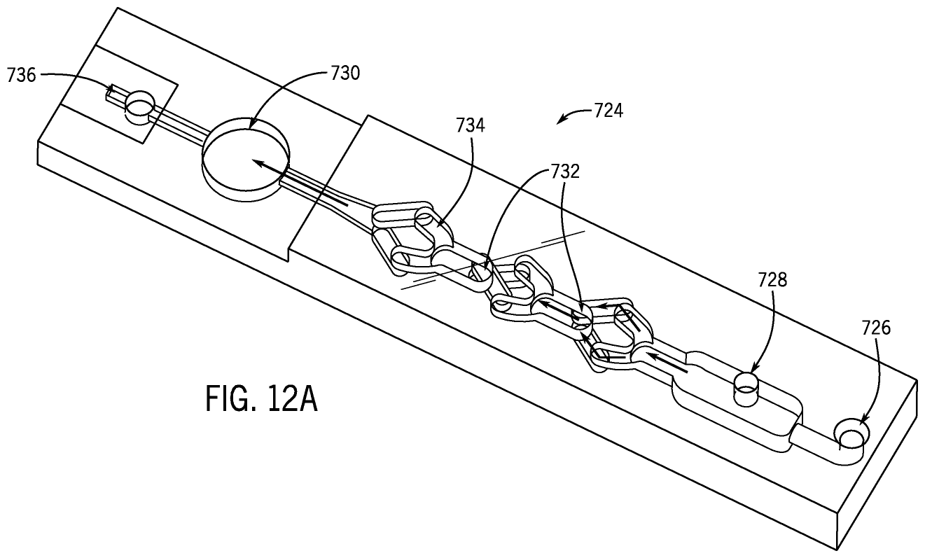

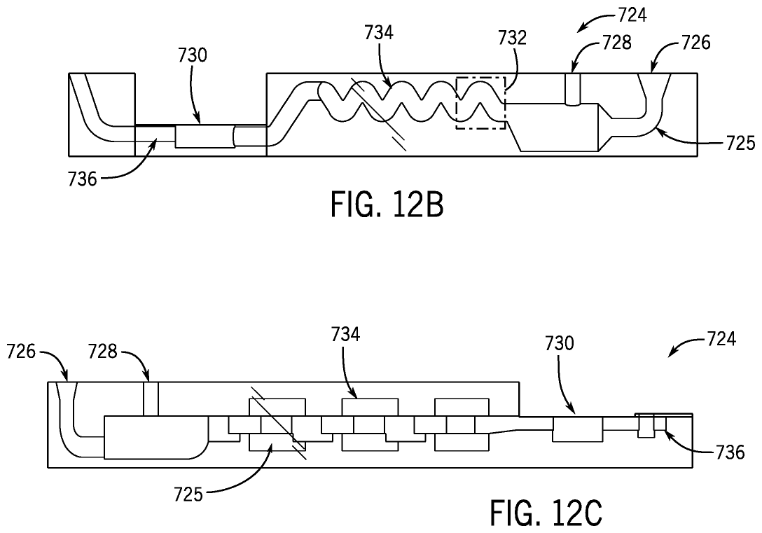

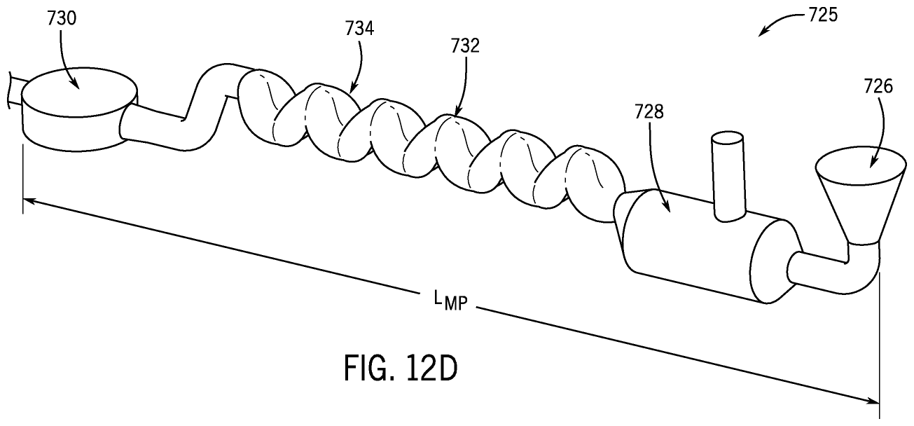

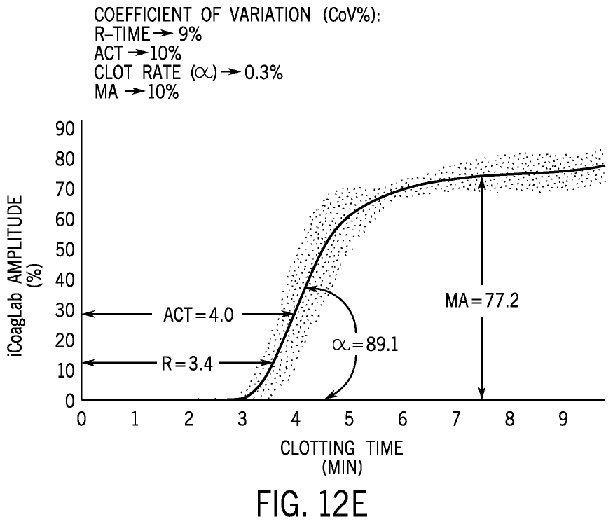

FIGS. 12A-D illustrate another millifluidic mixing cartridge 724 according to another embodiment of the disclosure. Similar to the cartridges described above, the mixing cartridge 724 can include a mixing passageway 725 with an inlet 726, a reagent chamber 728, and a test chamber 730. In use, a blood sample can be received by the cartridge 724 at the inlet 726, and via capillary action, air displacement, and/or gravity, can be moved to mix with the reagent at the reagent chamber 728, and onto the test chamber 730 for analysis. In some examples, the blood sample can be moved through the mixing passageway 725 by displacing air via, for example, capping the inlet 726 or air pressure from a syringe. The entire process can be relatively fast, such that complete mixing occurs on the order of seconds. For example, the mixing process may be completed in 30 seconds or less, 15 seconds or less, or 5 seconds or less.

In the illustrated embodiment, the cartridge 724 includes a plurality of recombining nodes 732. As the blood and reagent advance through the cartridge 724 toward the test chamber 730, mixing channels 734 provide a series of chaotic mixers and recombing nodes 732 to generate chaotic mixing. The recombining nodes 732 can be disposed at alternated top and bottom layers (see, for example, FIGS. 12B and 12C). Thus, in some embodiments, the nodes are in different planes. Mixing is achieved via fluid folding, inversion, and recombination steps. As shown in FIG. 12A, the millifluidic mixing cartridge 724 can also include a waste channel 736. The waste channel 736 can divert any excess sample (e.g., blood) and reagent mixture that is not needed or accommodated in the test chamber 730.

FIG. 12D shows the mixing passageway 725 in isolation. The mixing passageway 725 can define a length Lmp that extends the length of the mixing passageway between the inlet 726 and the test chamber 730. In general, the length Lmp of the mixing passageway 725 can be relatively small. For example, the length Lmp might be between approximately 4 cm and 20 cm, or between approximately 4 cm and 10 cm, or approximately 5 cm. Furthermore, the size (e.g., the diameter) of the channels that form the mixing passageway 725 may be between approximately 0.2 mm and 2 mm, or between approximately 0.8 mm and 1.3 mm.

FIG. 12E shows a general exemplary trace of iCoagLAB using three-dimensional millifluidics showing high precision (CoV<10%) and confirming feasibility of the cartridge 724 and other fluidic mixing devices described herein. In the example, 40 μL was used to test the concept. However, it should be appreciated that 25 μL of blood may also be used.

As described above, in general, a blood sample and a reagent can be effectively mixed by traversing a set of three-dimensional curved, turned, zigzagged, or helical channels that intersect at a plurality of nodes. That is, the nodes can fluidly couple two or more distinct channels so that as fluid passes through each node, the fluid is split along separate channels until being recombined (and possibly split again) at subsequent nodes. The processes of splitting, combining, re-splitting, and recombining fluid allows for a first fluid (e.g., a blood sample) and a second fluid or element (e.g., a reagent) to be effectively and efficiently mixed so that analyses can be done on the mixture.

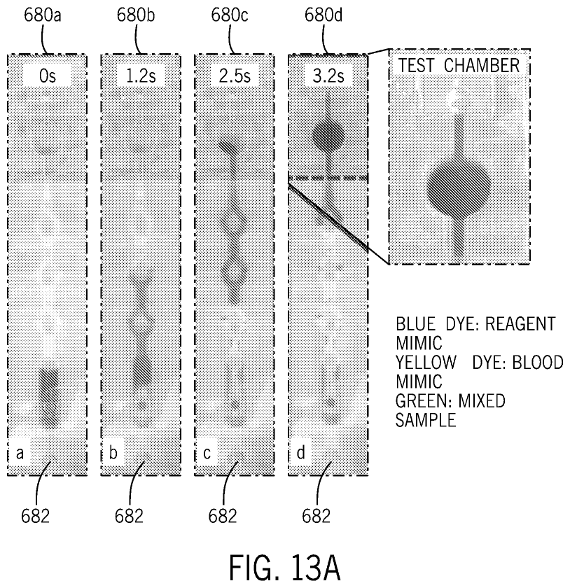

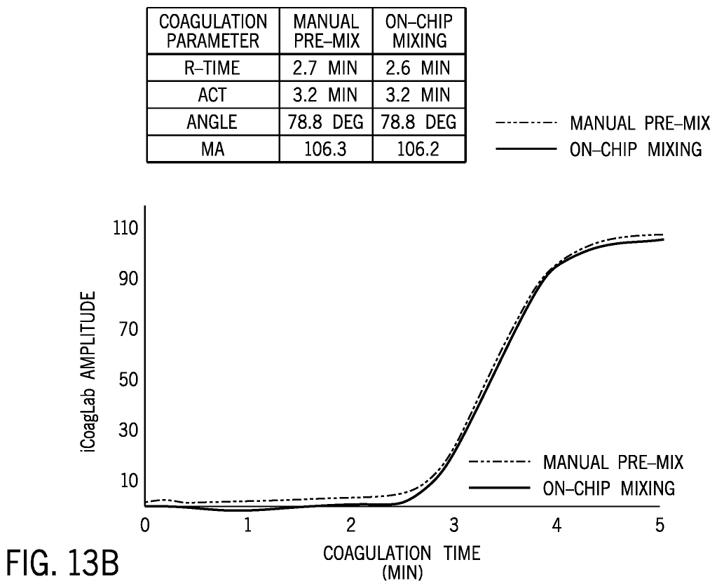

FIG. 13A illustrates a cartridge 680a having 60% glycerol diluted in water that has been introduced at an inlet 682. Cartridge 680b illustrates a purge of air that has been introduced at the inlet 682. Cartridges 680c and 680d illustrate liquid rapidly advancing through the cartridge and combining and mixing.

FIG. 13B illustrates data collected relating to coagulation parameters detected from a mixture analyzed at an imaging area of a cartridge shown in FIG. 13A. The data displayed in FIG. 13B reflects a reagent (e.g., liquid kaolin) pre-loaded into a reagent chamber. An analyzer (e.g., iCoagLab) can trace viscoelastic of a mixture. The mixtures compared include a pre-mixing (control) versus on-chip passive mixing (experimental). The data shows nearly identical parameters traced, which can confirm the accuracy and precision of passive mixing methods shown in FIG. 13A and overall described herein.

Embodiments of passive fluidic mixing concepts described herein can leverage intrinsic capillary forces, or a piston or capping mechanism, to displace air in an inlet chamber to advance blood through a series of inversion mixers and recombination nodes that produce chaotic advection. Capillary forces may be advantageously effective for mixing very small volumes of blood (e.g., less than 25 μL) and a capping or piston mechanism may be advantageously effective for mixing relatively larger amounts of blood (e.g. between approximately 25 and 200 μL). Thus, continuously splitting, recombining, and folding fluid streams in three dimensions can limit rouleaux formation and permit effective mixing of whole blood and wet or dry reagents despite differences in densities and viscosities. Data collected in studies conducted using methods described herein show that concepts according to embodiments of the invention permit excellent on-chip mixing within approximately 5 seconds. Data also shows coagulation results identical to manual pre-mixing (see, for example, FIG. 13) and high precision between replicate measurements (coefficient of variation CoV)~10%). The millifluidic mixing strategy described herein can enable precise blood mixing (defined by lower CoV) by adjusting and optimizing the diameters of chaotic mixers and recombination nodes. Additionally, embodiments of the invention can employ hydrophobic surfaces and materials to reduce dead volume (i.e., blood left behind in channels).

In general, the following parameters can be optimized for precise reagent and blood mixing: incubation time of blood within the reagent chamber (e.g., varied between 5 and 60 seconds), length and diameters of channels, and the number of mixer elements or recombinant nodes. These parameters may be optimized based on reagent, blood volume, blood type, and other mixing element or environmental factors or properties.

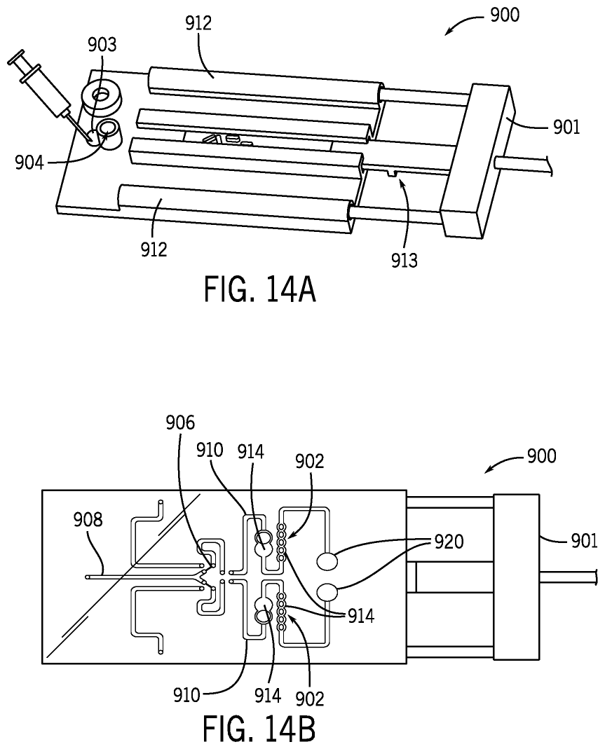

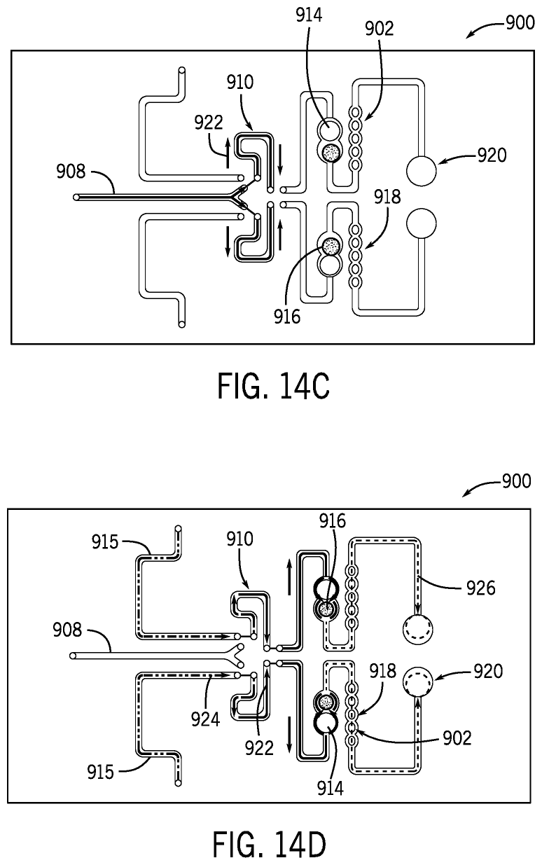

With reference now to FIGS. 14A-D, an embodiment of a multiplexed, millifluidic cartridge assembly with a plurality of test channels 902 is shown. The blood cartridge 900 can include a piston or static plunger 901, that in some embodiments, may be integrated with the cartridge 900 or a cartridge nest. The blood cartridge 900 incorporates the microfluidic and/or millifluidic mixing channels 902 as discussed above. In general, the blood cartridge 900 can be optimized for ease of use, such the blood 903 is introduced by the user into an inlet 904. In some embodiments, the blood 903 may be introduced by a syringe or other vessel. The cartridge 900 can than be introduced over a static sliding valve 906 optionally incorporated in an instrument to initiate mixing.

In its initial position, the sliding valve 906 connects an input channel 908 with a metering channel 910 so that a precise amount of blood (e.g., 25 μL) is metered. Insertion of the cartridge 900 over the sliding valve 906 pressurizes air within side rails 912 to push metered blood 903 through the premixing and reagent wells 914. As the blood 903 moves through the premixing and reagent wells 914, it mixes with a reagent 916 (e.g., lyo-bead) driving the mixture through chaotic mixers 918 and to testing chambers 920.

With reference to FIG. 14C, in use, first an input volume of blood 903 (e.g., less than or equal to 50 μL) will move in the input channel 908 via hydrostatic pressure, capillary forces, or with the help of a capping element (see, for example, cap 610 in FIG. 5B). The initial blood flow is illustrated with arrows 922. Next, with reference to FIG. 14D, after the blood input, the cartridge 900 may be flipped over and inserted into a test instrument (not shown). The static plunger 901, which may be disposed on the test instrument, can push the valve 906 till a relative stopper hits a base of the cartridge 900. At the same time, air inside the side rails 912 will be pressurized and push the blood 903 through the premixing wells 914, picking up the reagent 916, and moving through the passive recombinant mixers 918. The mixture of the blood 903 and reagent 916 will then be moved to the testing chamber 920 for testing. The movement of pressed air from the static plunger 901 to urge the blood 903 toward the testing chamber 920 is indicated by arrows 924 in FIG. 14D and the movement of the mixture of blood 903 and the reagent 916 is indicated by arrows 926 in FIG. 14D.

An exemplary workflow of the cartridge 900 can include the following steps. Step 1: the cartridge 900 can be advanced into a cartridge slot until an initial stop position via a stop 913. This aligns the slider valve 906 to connect the inlet 904 and metering channels 910. Step 2: Blood is then introduced into the inlet port 904, which has a fill line indicator to ensure sufficient volume. Under hydrostatic pressure, the blood advances and splits into the metering channels 910 (e.g., 25 μL each) which also contains a reagent (e.g., lyobeads). Step 3: The cartridge 900 is advanced to a final stop position via a second stop. This engages the piston or plunger 901 incorporated in the cartridge slot, which displaces air through the side rails of the cartridge into air channels 915, shown in FIG. 14D. In this position, the sliding valve also connects the air channels 915, the metering channels 910, and the mixing channels 918, rapidly purging blood combined with reagents from the metering channels 910 toward the three-dimensional recombinant mixing nodes 918, coming to a stop in the test chambers 920. In the illustrated embodiment, the test chambers 920 are spaced approximately 7.6 mm apart.

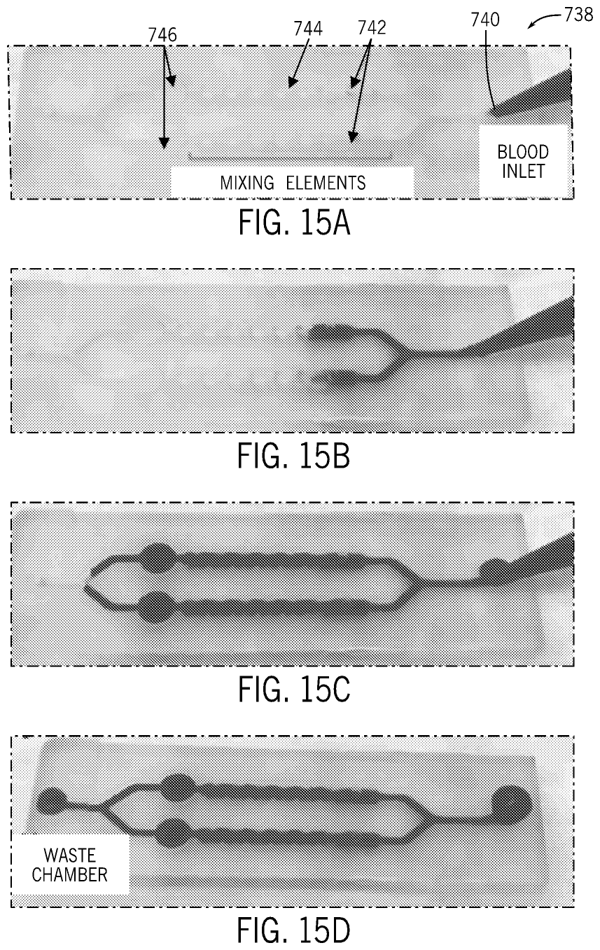

FIGS. 15A-D illustrate images of cartridges 738 being filled with blood which travels from a blood inlet 740, to reagent chambers 742, through mixing channels 744, and into test chambers 746. In general, FIGS. 15A-D illustrate chaotic-mixing in a 3D printed dual-chamber mixer. As blood flows through the capillary channels (e.g., the mixing channel 744), the blood is combined with the pre-loaded reagents and can undergo complete mixing within 5 seconds. Complete mixing refers to a mix that is sufficient for accurate analysis.

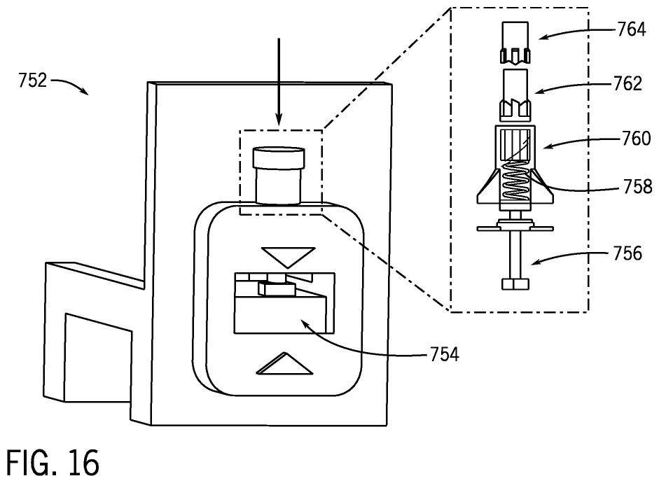

FIG. 16 illustrates an exemplary method of a capping system 752 for an inlet section of a millifluidic cartridge 754 with an optional spring-loaded piston or plunger 756. The piston or plunger 756 can displace air and push blood toward millifluidic mixing channels of the cartridge 754, which may be similar to the millifluidic cartridges described above. The piston or plunger 756 can be spring-operated, and include a spring 758, a housing 760, and a set of cams 762. The piston or plunger 756 can further include an actuator 764, such as a button, to actuator the plunger 756. In some embodiments, only a single plunge is needed to push the blood through the mixing channels. And in some embodiments, actuating the plunger 756 can include a single push, which keeps the plunger 756 in an extended an actuated position until the actuator 764 is released. The capping system 752 illustrated in FIG. 16 may be advantageous with displacing and mixing larger volumes of blood, such as greater than 100 μL of blood, for example. As described above, for smaller volumes of blood, the blood displacement may be accomplished by placing a cover over an inlet of a cartridge to advance the blood through mixing channels.

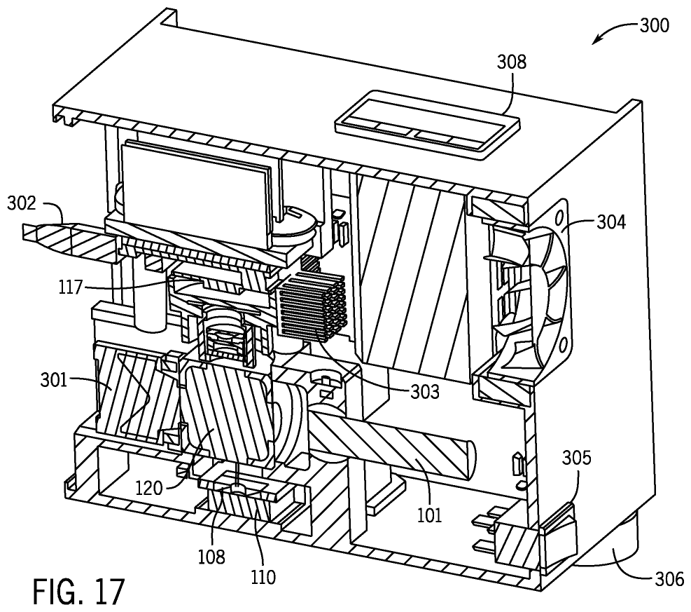

With reference now to FIG. 17, an exemplary embodiment of a blood coagulation monitoring system 300 is shown. Components used in the blood coagulation monitoring system 300 that were previously described with respect to the blood coagulation monitoring system 150 can be used in the blood coagulation monitoring system 300. Thus, like reference numbers will be used where applicable and the same or similar description as discussed above can be applied to the blood coagulation monitoring system 300 of FIG. 17.

Similar to the blood coagulation monitoring system 150, the blood coagulation monitoring system 300 can include a beam splitter 120. In use, a light can pass through the beam splitter 120 and can be captured by a beam dump 301 (e.g., to safely absorb energy). Speckle patterns imaged on the sensor 117 can be transferred to a processor 118 by an electrical wire 302. To reject heat from a sensor 117, the blood coagulation monitoring system 300 can include several heat sinks 303 and a fan 304. A holder 110 can incorporate a temperature controller 308 to keep a blood sample at approximately 37 degrees Celsius (or other temperature). A coherent light source 101, the temperature controller 308, and the fan 304 can be actuated via a switching system 305. Additionally, the system 300 can incorporate a vibration isolator 306.

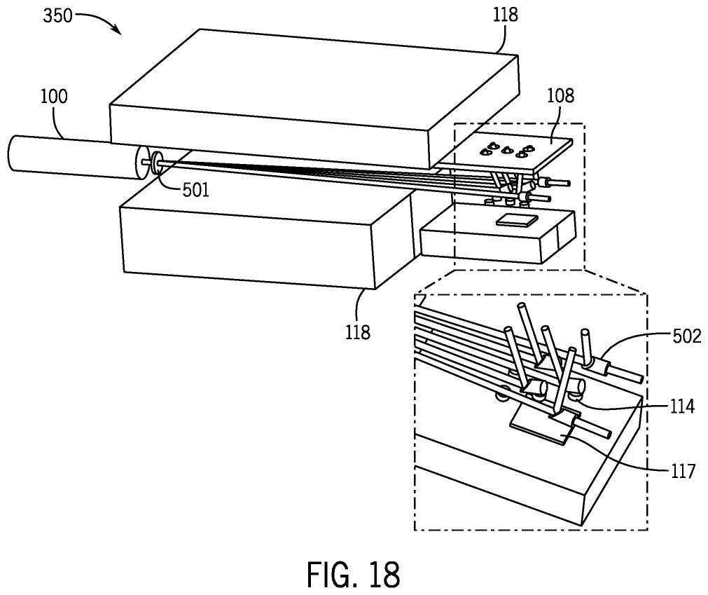

FIG. 18 shows another exemplary embodiment of a blood coagulation monitoring system 350 according to an embodiment of the disclosure that details an illumination system for shining light on a plurality of test channels of a chamber in a cartridge, such as the cartridges described above. Like the blood coagulation monitoring system 300, the blood coagulation monitoring system 350 can include similar components to the blood coagulation monitoring system 150 of FIG. 1. Thus, like reference numbers to the same or similar components will be used where applicable.

The blood coagulation monitoring system 350 can use a plurality of light beams. A light from a coherent light source, such as the coherent light source 100, reaches to Diffractive Optical Elements (DOE) 501, which has microstructure to diffract an incident light to plural beams. Alternatively, the microstructure may direct light through reflection or refraction to plural beams. Here, the DOE 501 can split an incident light into mainly 5 beams with a certain separation angle, such as 1.5 degrees, for example. Each split beam can reach to a small right angle mirror 502 to illuminate 5 imaging wells incorporated to a blood sample chamber 108. Scattered light in blood samples are imaged on a sensor 117 through lenses 114. In one example, the small right angle mirrors 502 are located not to block the imaging arms. Captured speckle images can be simultaneously imaged by an imaging lens, an optional polarizer, and aperture system to the camera sensor and transferred to a processor such as the processor 118. For light splitting purpose, a fiber based beam coupler also can be applied.

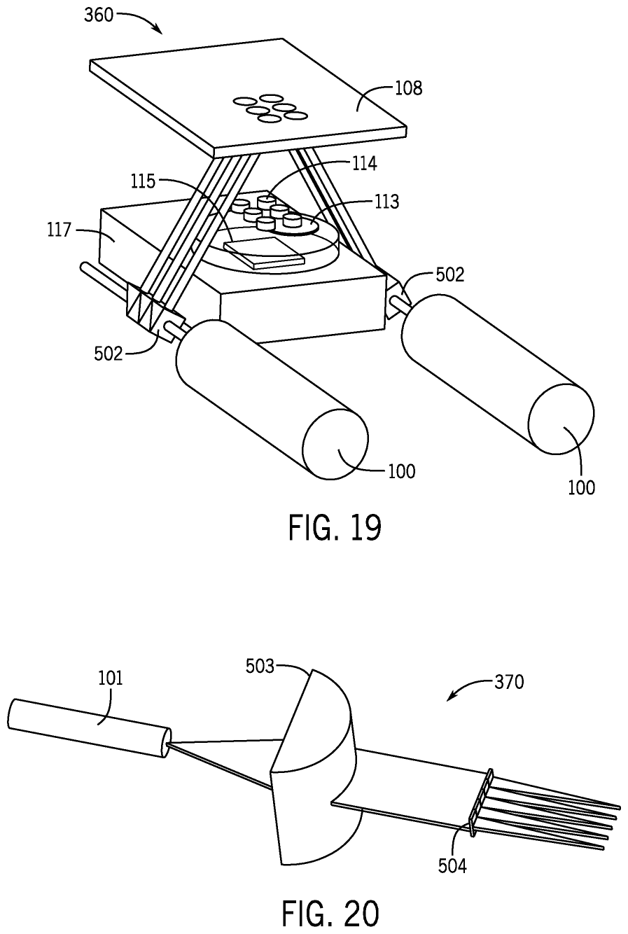

FIG. 19 shows another exemplary embodiment of a blood coagulation monitoring system 360 using a plurality light beams according to an embodiment of the disclosure. Similar to the blood coagulation monitoring systems described above, the blood coagulation monitoring system 360 can include similar components to other blood coagulation monitoring systems described herein. Thus, like reference numbers to designate the same or similar components described above will be used where applicable.

The blood coagulation monitoring system 360 can include two coherent light sources 100 that can be used for illumination. One difference between the blood coagulation monitoring 360 of FIG. 19 and the blood coagulation monitoring 350 of FIG. 18 is the power of coherent light. Right angle mirrors 502 can be used to illuminate each imaging well with equal powers. In some embodiments, a plurality of light sources may include similar wavelengths to increase optical power on a sample as-needed. Alternatively, other sources of different wavelength may be used to detect additional information from wavelength-dependent optical properties of samples.

As shown in FIG. 19, the blood coagulation monitoring system 360 can include an aperture 113, a lens 114, and a linear polarizer 115. The linear polarizer 115 can be used to select a polarization state of a speckle image. Additionally, the blood coagulation monitoring system 360 can include one or more light sources 100 that are axially and laterally displaced from the blood sample chamber 108. This can allow for a variety of orientations and configurations of each of the light sources 100, the blood sample chamber 108, and the sensor 117.

FIG. 20 shows another exemplary embodiment of a blood coagulation monitoring system 370 using a plurality light beams according to an embodiment of the disclosure. Similar to the blood coagulation monitoring systems described above, the blood coagulation monitoring system 370 can include similar components to other blood coagulation monitoring systems described herein. Thus, like reference numbers to designate the same or similar components described above will be used where applicable.

The blood coagulation monitoring system 370 can include a coherent light source 101 that emits a fan shape of coherent light to reach a collimator lens 503 to make the coherent light collimated. A collimated beam reaches illuminations lenses 504 that are linked up in the same direction as the collimated line beam. Each illumination lens 504 can focus a light to a point, and in the example of FIG. 20, there is five focused points. The pitch (e.g., distance between pointed ends) of each focused point is equivalent to a pitch of imaging well in a blood sample chamber 108. The optical axes of five beams can be bent by using a mirror when the normal line of imaging wells are perpendicular to the optical axes. Alternatively, a cylindrical lens may be used to illuminate a line across a plurality of test chambers.

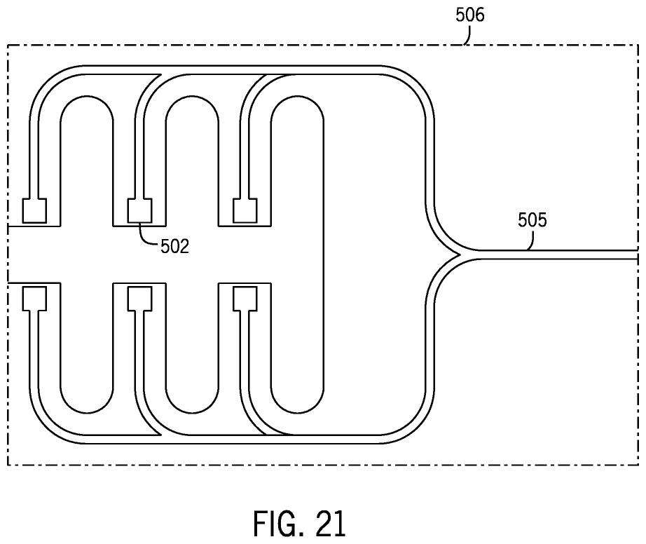

FIG. 21 illustrates another example configuration for outputting a plurality illumination light according to an embodiment of the disclosure. An optical wave guide (OWG) 506 can be used to split a coherent light. For example, the OWG 506 can split light emitted from a light source and direct light at a plurality of blood reservoirs in a fluidic holder that contains a sample of blood. A coherent light can be coupled to the side of a core 505 to split the light six ways. However, in other example, the light can be split n ways, where n is an integer between 1 and 10. The core 505 can be the size for multi-mode condition for wavelength of coherent light, but preferably single-mode condition for wavelength of coherent light. The OWG 506 can also incorporate a right angle mirror 502.

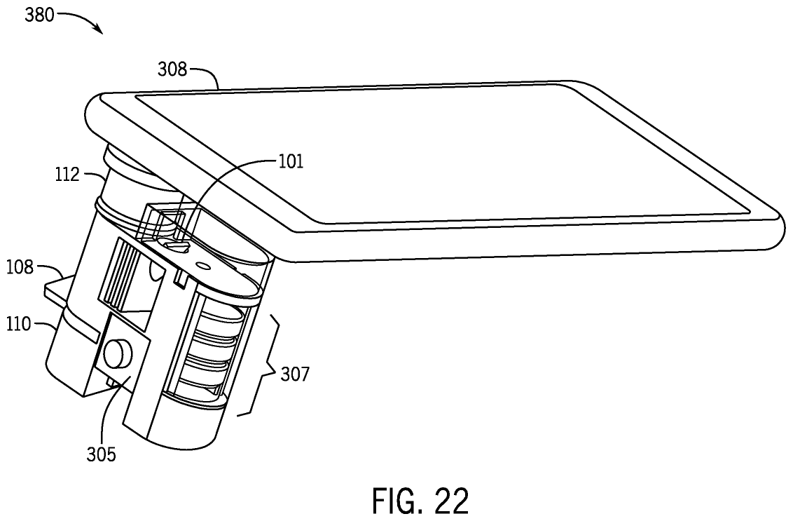

FIG. 22 illustrates a schematic diagram of another example embodiment of a blood coagulation monitoring system 380. Similar to the blood coagulation monitoring systems described above, the blood coagulation monitoring system 380 can include similar components to other blood coagulation monitoring systems described herein. Thus, like reference numbers to designate the same or similar components described above will be used where applicable. A coherent light source 101 of the blood coagulation monitoring system 380 can directly illuminate a blood sample chamber 108 with a tilted angle to avoid capturing direct reflection by a sensor. Scattered light from the blood sample chamber 108 can pass through an imaging optics unit 112 and can be captured by a smartphone 308 (or other device that may be portable, such as a tablet or other computing device) that can incorporate a sensor unit (e.g., the sensor 117).

The smartphone device 308 also incorporate a processor 118 inside. A holder 110 can secure a blood sample chamber 108 perpendicular to gravity axis. This blood coagulation monitoring system 380 can incorporate a battery 307 to power the coherent light source 101 and a fan (e.g., the fan 304) that may be located at a back side of the system. The coherent light source 101 and the fan 304 can be actuated by a switching system (e.g., the switching unit 305).

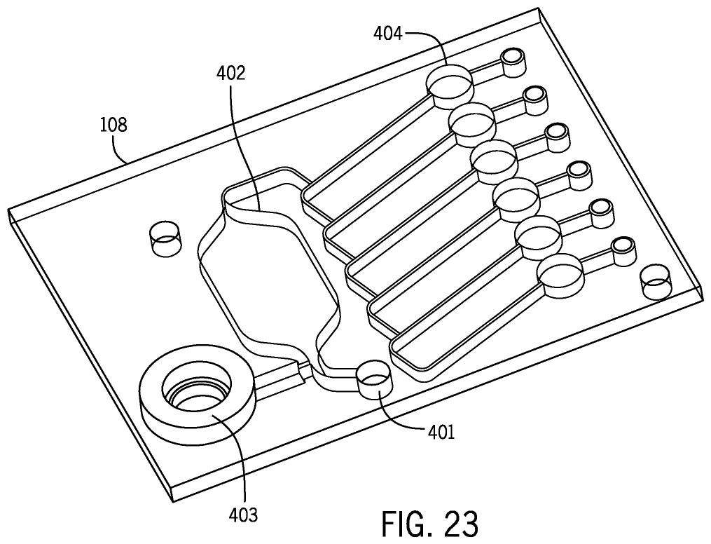

FIG. 23 shows a diagram of a holder for a blood chamber 108. In use, a blood sample can be injected at an injection point 401 and stored in a reservoir 402. A pumping system (not shown in FIG. 23) can apply pressure to a pressure area 403 to mix with a reagent. Such reagent can be, for example, Kaolin. The reagent can be placed in paths of blood and push mixed blood to an imaging area 404. In the illustrated embodiment, there are multiple imaging areas 404 that can be used for testing different assays at the same time, or otherwise substantially simultaneously. The imaging area 404 can include a plurality of imaging chambers. In the illustrated embodiments, there are six imaging chambers (e.g., similar to the imaging chamber 601 of FIG. 3).

In some embodiments, a blood chamber, such as the blood chamber 108 may only require a relatively small volume of blood for an analysis process. For example, a small volume of blood, such as less than 1000 μl may be inserted into the blood chamber 108 and stored in the reservoir 402. In other embodiments, the blood sample may be between 25 and 800 μl, or between 25 and 400 μl, or less than 100 μl, or less than 20 μL in the case of micromixers. This volume of blood can be distributed across (e.g. equally) the imaging chambers of the imaging area 404 for multiple, individual analyses.

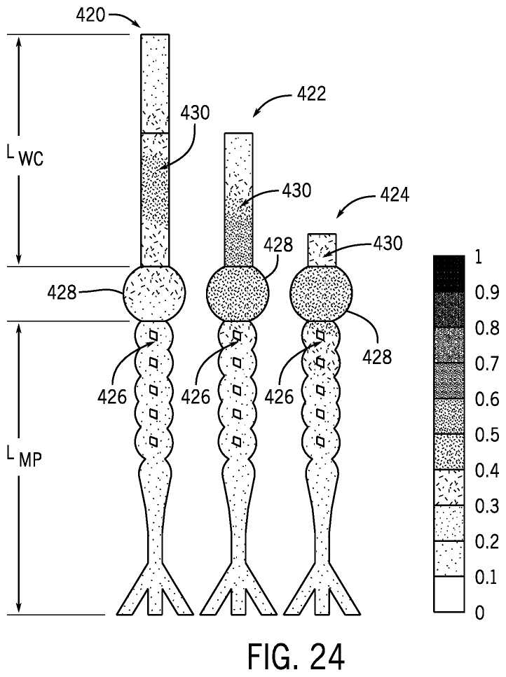

FIG. 24 illustrates an optimization analysis for nodal mixing versus a waste channel length in fluidic mixing devices, such as those described herein. FIG. 24 includes an analysis with a first fluid passageway 420, a second fluid passageway 422, and a third fluid passageway 424. As shown, each of the fluid passageways 420, 422, 424 include the same length Lmp of mixing passageway. However, the waste channels 430 of each of the fluid passageways 420, 422, 424 are different lengths. The first fluid passageway 420 includes a waste channel 430 having a first waste channel length Lwc. The second fluid passageway 422 includes a waste channel 430 with a shorter waste channel length than the first fluid passageway 420, and the third fluid passageway 424 includes a waste channel 430 with a shorter waste channel length than both of the first and second fluid passageways 420, 422. As shown, the mixing passageway (Lmp) extends from an inlet, through the nodal region 426, and to the respective test chamber 428. The waste channel extends beyond the test chamber 428.

The optimization analysis shows that the length Lwc of the waste channel 430 of the first fluid passageway 420 promotes a more complete mixture in the test chamber 428 compared to the fluid passageways 422 and 424, which have shorter waste channels 430. Thus, there is an optimal waste channel 430 length so that complete mixing occurs in the nodal region 426 and is analyzable in the test chamber 428. In the illustrated embodiment, an optimal volume of the waste channel 430 is between approximately 5% and 15%, or between approximately 8% and 12%, or approximately 10% of the total blood and reagent volume within the fluidic device.

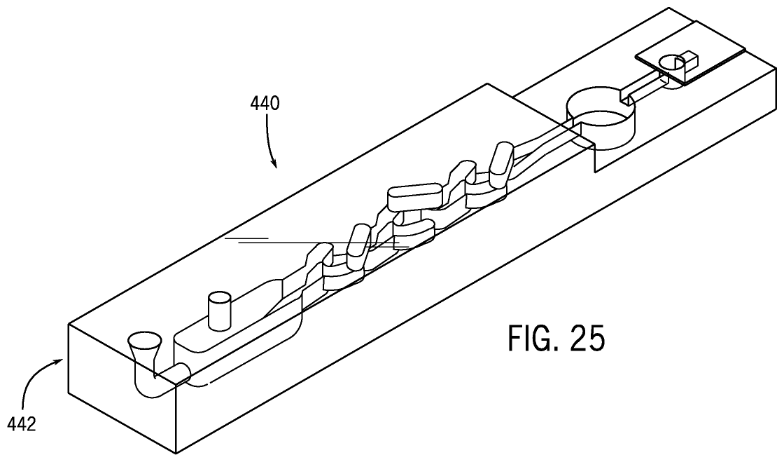

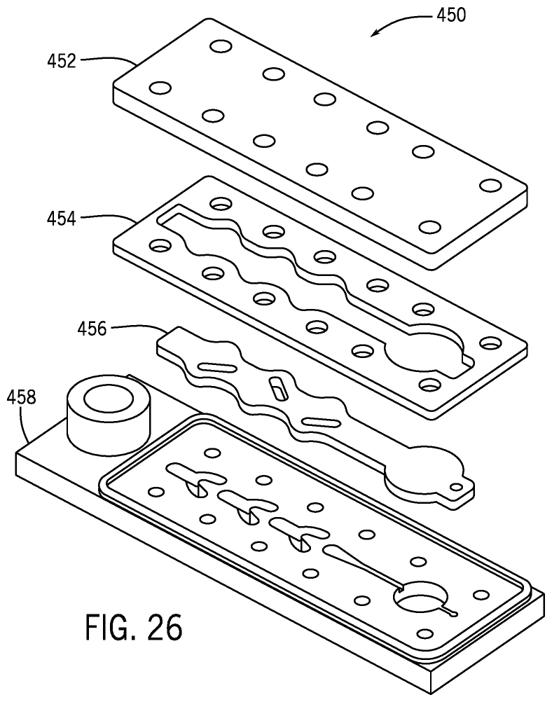

FIGS. 25 and 26 illustrate additional embodiments of microfluidic devices. As described above, some microfluidic devices can be formed via additive manufacturing (e.g., 3D printing). However, in some instances, these methods of manufacturing can be costly or having other drawbacks. Thus, it may be useful to employ other methods of manufacturing, such as injection molding, for example. However, in some cases, it can be challenging to mold three-dimensional intertwined helicoidal channels.

FIG. 25 illustrates an embodiment of a fluidic device 440. The device 440 can include a plurality of layers 442. Each of the layers may be individually manufactured (e.g., injection molded) and then assembled to form the device 440. It should be appreciated that the device 440 is by way of example, and any of the fluidic devices described herein could be formed from similar layering techniques.

FIG. 26 illustrates another embodiment of a fluidic device 450. The device 450, like the device 440, can include a plurality of layers. For example, the device 450 can include a top plate 452, one or more shims 454, one or more gaskets 456, and a base 458. Each of these layers can be formed individually, and then assembled to form the fluidic device 450.

Embodiments of the present disclosure provide fluidic devices that can efficiently and effectively mix blood samples and reagents. This can be useful in a variety of industries, including point of care. In general, testing different assays comprised of the same blood sample can increase the accuracy of test results by increasing the sample size in which the tests are performed. As briefly discussed above, various blood coagulation monitoring techniques can be subject to calibration requirements and other factors that may impact test results. In this regard, embodiments of the present disclosure can provide systems and methods for testing a single, microfluidic volume of fluid and reporting results with improved accuracy when compared to conventional approaches. For example, embodiments of the present disclosure can provide sub-tests within a single test that can be individually analyzed and inconsequentially discarded if outlier results are determined. The remaining sub-tests can then be analyzed to produce a result (e.g., coagulation parameters) that are both accurate and consistent across a single sample. As described above, these sub-tests may be carried out individually or in parallel across an imaging area (e.g., the imaging area 404) having a plurality of imaging chambers.

According to embodiments of the present disclosure, a number of coagulation parameters may be measured simultaneously or serially from a plurality of test chambers from laser speckle patterns reflected from blood within test chambers. For example, an intrinsic coagulation cascade may be measured by kaolin activation by introducing a kaolin reagent to measure activated clotting time, clot ate, clot angle, clot stiffness or amplitude or diminishing clot stiffness (fibrinolysis). In addition, the extrinsic coagulation cascade may be measured from the same channel via tissue factor or thromboplastin activation to measure prothrombin time or international normalized ration (INR), and additional metrics related to fibrinogen or fibrin polymerization measured by monitoring intensity fluctuations of laser speckle reflected from test chambers. Alternatively or additionally, other factor specific assays may be measured to quantify coagulation factors such as factor X, factor XIII, or factor IIIX. From laser speckle patterns upon addition of specific reagents. Finally, platelet functional testing may be conducted by measuring the mean square displacements or growing particle sizes of aggregating platelets form speckle patterns reflected from a plurality of test chambers.

While the system and methods for microfluidic and millifluidic mixers have used the term “blood” above, all of the approaches for helicoidal mixing are also applicable for mixing other fluids, particularly biofluids, such as serum, plasma, urine, cerebrospinal fluid, or other fluids or materials when mixing between fluids or matter of distinctly different viscosities or densities is necessary.

Further, it should be appreciated that varying components of the blood coagulation monitoring systems, beam splitters, and microfluidic cartridges having one or more imaging chambers can be interchanged with the various systems and cartridges described herein and others. Thus, components of the various examples described herein should not be limited to the individual example, and can be incorporated into other embodiments.

Within this specification embodiments have been described in a way which enables a clear and concise specification to be written, but it is intended and will be appreciated that embodiments may be variously combined or separated without parting from the invention. For example, it will be appreciated that all preferred features described herein are applicable to all aspects of the invention described herein.

Thus, while the invention has been described in connection with particular embodiments and examples, the invention is not necessarily so limited, and that numerous other embodiments, examples, uses, modifications and departures from the embodiments, examples and uses are intended to be encompassed by the claims attached hereto.

Various features and advantages of the invention are set forth in the following claims.

1. A fluidic cartridge for mixing a fluid sample with a reagent, the fluidic cartridge comprising:
a sample reservoir dimensioned to receive the fluid sample;
a reagent reservoir dimensioned to receive the reagent, the reagent reservoir in fluid communication with the sample reservoir;
a plurality of mixing elements organized in series in fluid communication with the reagent reservoir, the plurality of mixing elements defining a three-dimensional geometry connected via a plurality of nodes through which the fluid sample and the reagent flow and recombine; and
an imaging chamber in fluid communication with the plurality of mixing elements, the imaging chamber dimensioned to receive an analyzable mixture of the fluid sample and the reagent.

2. The fluidic cartridge of claim 1, wherein at least one node of the plurality of nodes fluidly couples at least two mixing elements of the plurality of mixing elements so that fluid flowing past the at least one node is split, redirected via separate planes, combined, or recombined to facilitate mixing.

3. The fluidic cartridge of claim 1, wherein the three dimensional geometry includes turns that redirect flow between at least two distinct planes separated in depth.

4. The fluidic cartridge of claim 1, wherein the sample reservoir is in fluid communication with a sample inlet, the sample inlet dimensioned to receive an inlet cap after the fluid sample has been inserted into the sample reservoir via the sample inlet, the sample cap configured to displace the fluid sample and urge the fluid sample toward the reagent reservoir.

5. The fluidic cartridge of claim 1, wherein the fluid sample and the reagent move along the mixing elements to form a mixture in less than 10 seconds, inclusive.

6. The fluidic cartridge of claim 1, wherein the fluid sample and the reagent travel toward the imaging chamber via capillary flow.

7. The fluid cartridge of claim 1, wherein the fluidic cartridge is configured as a microfluidic mixer cartridge.

8. The fluidic cartridge of claim 1, wherein the fluidic cartridge is configured as a millifluidic cartridge.

9. The fluidic cartridge of claim 1, wherein the sample fluid is blood, and, wherein the reagent is a pre-loaded reagent secured within the reagent reservoir.

10. The fluidic cartridge of claim 1, further comprising:
one or more overfill channels that can accommodate an excess of the fluid sample or a mixture thereof so that a predetermined analyzable volume of an analyzable mixture of the fluid sample and reagent is received by the imaging chamber.

11. The fluidic cartridge of claim 1, wherein the imaging chamber is one of a plurality of imaging chambers permitting a plurality of fluid sample and reagent mixtures to be analyzed.

12. A fluidic cartridge for mixing a blood sample with a reagent, the fluidic cartridge comprising:
a sample inlet in fluid communication with a sample reservoir, a reagent inlet in fluid communication with a reagent reservoir, the reagent reservoir downstream of the sample reservoir;
a mixing passageway having a series of mixing elements including one or more channels and a plurality of nodes;
a test chamber configured to receive a mixed solution of the blood sample and the reagent; and
a waste chamber dimensioned to receive excess blood sample and reagent.

13. The fluidic cartridge of claim 12, wherein the waste chamber defines a volume that is greater than 10% of a total volume of blood sample and reagent.

14. The fluidic cartridge of claim 12, wherein the one or more channels have a diameter between 0.8 mm and 1.3 mm.

15. The fluidic cartridge of claim 12, wherein the series of mixing elements extend in three dimensions to provide turbulent or chaotic mixing of the blood sample and the reagent.

16. A method of mixing blood and a reagent, the method comprising:
inserting a blood sample into a sample reservoir of a fluidic device;
inserting the reagent into a reagent reservoir of the fluidic device;
generating chaotic mixing of the blood sample and the reagent by urging the blood sample and the reagent through a mixing passageway having a plurality of combining and recombining nodes;
sending a fully mixed solution of the blood sample and the reagent to a test chamber of the fluidic device; and
expelling excess blood sample and reagent not accommodated by the test chamber into a waste passageway.

17. The method of claim 16, wherein urging the blood sample and the reagent through the mixing passageway includes displacing air withing the mixing passageway.

18. The method of claim 17, wherein displacing air includes capping an inlet to the sample reservoir.

19. The method of claim 16, wherein urging the blood sample and the reagent through the mixing passageway includes capillary flow.

20. The method of claim 15, wherein the blood and the reagent are fully mixed in 5 seconds or less.

21. The method of claim 15, wherein the blood sample and the reagent travel in three-dimensions through the mixing passageway.

22. A method of mixing blood and a reagent, the method comprising:
inserting a mixing cartridge into a cartridge slot until an initial stop position to align a slider valve to connect an inlet of the mixing cartridge with metering channels of the mixing cartridge;
inserting a blood sample into an inlet of the mixing cartridge;
advancing the blood sample, via hydrostatic pressure, into the metering channels;
advancing the mixing cartridge within the cartridge slot to a final stop position to connect air channels of the mixing cartridge with the metering channels and and mixing channels of the mixing cartridge; and
rapidly purging the blood sample combined with the reagent through the mixing channels and to a test chamber of the mixing cartridge.

23. The method of mixing blood and a reagent, wherein rapidly purging the blood sample combined with the reagent through the mixing channels includes sending the blood sample combined with the reagent to a plurality of test chambers to be simultaneously tested.
